(19) United States
(12) Patent Application Publication
(10) Pub. No.: US 2026/0260251 A1
(43) Pub. Date: Sep. 3, 2026

(54) DOMAIN-ORIGIN BEI INTERNET ECONOMY INFRASTRUCTURE FOR REDEFINING DOMAIN NAMES, INTERNET CONTROL PLANES, AND BEHAVIORAL-ECONOMIC VALUE CLEARING

(71) Applicant: FURONG BEI, San Gabriel, CA (US)

(72) Inventor: FURONG BEI, San Gabriel, CA (US)

(21) Appl. No.: 19/686,756

(22) Filed: May 24, 2026

Related U.S. Application Data
(63) Continuation-in-part of application No. 19/058,739, filed on Feb. 20, 2025.
(63) Continuation-in-part of application No. 19/064,689, filed on Feb. 27, 2025.
(63) Continuation-in-part of application No. 19/067,845, filed on Mar. 1, 2025.
(63) Continuation-in-part of application No. 19/067,936, filed on Mar. 2, 2025.
(63) Continuation-in-part of application No. 19/067,907, filed on Jan. 1, 0001.
(63) Continuation-in-part of application No. 19/069,278, filed on Mar. 4, 2025, now abandoned.
(63) Continuation-in-part of application No. 19/069,205, filed on Mar. 3, 2025, now abandoned.
(63) Continuation-in-part of application No. 19/069,285, filed on Mar. 4, 2025.
(63) Continuation-in-part of application No. 19/069,268, filed on Mar. 4, 2025, now abandoned.
(63) Continuation-in-part of application No. 19/069,264, filed on Mar. 4, 2025.
(63) Continuation-in-part of application No. 19/069,257, filed on Mar. 4, 2025.

(51) Int. Cl. G06Q 30/018; G06Q 50/26

(52) U.S. Cl. CPC G06Q 30/018; G06Q 50/26

(57) ABSTRACT

A BEI domain-origin infrastructure redefines a network domain name as a BEI Domain Basepoint Node for Behavioral-Economic Identity, redefines the Internet as a BEI policy-executing and proof-generating control plane, and redefines Internet Economy as a BEI co-owner value network. Object-confirmed life-time behavior events are bound to BEI identity, domain-origin scope, Time-of-Time coordinates, object references, evidence digests, deterministic policy containers, non-duplication references, and Q-qualified grades to generate BEI-TVP or BEI Fission Root records. The records are routed through ATMS, BEIMINT or MF, BEI Currency, TimeCurrency, BEIGX, BEIIndex, and BEIMarket nodes for domain-origin value routing, authorization, clearing, index publication, and market licensing. Proof artifacts including RRec, Marker, ACR, FinalityMarker, NonDuplicationReceipt, and RBP support minting, settlement, indexing, licensing, claim-to-SKU asset-package mapping, and BEIFR2 bounded remediation while preserving append-only audit trails and enabling verifier reconstruction across heterogeneous networks, industry packs, jurisdiction packs, and systems.

### CROSS-REFERENCE AND PORTFOLIO STATUS HANDLING

This disclosure is intended to preserve and strengthen the useful substance of prior BEI, ATMS, BEISOS, TimeCurrency, BEIMINT, BEIDNS, BEIFR2, and related portfolio materials while standing on its own written description and enablement.

Paid, co-pending, and complete-fee applications may be identified in an Application Data Sheet as domestic benefit, continuation, continuation-in-part, or related applications only after confirmation of legal status, pendency, inventorship, and claim support. Expired, lapsed, unpaid, or abandoned materials are not relied upon for priority unless separately revived or confirmed; their useful technical concepts are rewritten here as present disclosure.

The present invention is not a compilation of domain names, not a mere super-application, not a marketing plan, and not an abstract economic idea. It is a domain-origin, computer-implemented infrastructure control plane that uses deterministic policy execution and proof-carrying artifacts to convert object-confirmed behavioral-economic identity events into verifiable, non-duplicative, clearable, licensable, and bounded-remediable BEI value records.

### TECHNICAL FIELD

The disclosure relates to domain-anchored network infrastructure, behavioral-economic identity systems, deterministic policy-container execution, proof-carrying receipts, time-denominated and behavior-denominated value units, atomic clearing finality, bounded remediation, and asset-package licensing infrastructure across heterogeneous Internet, financial, medical, IoT, and institutional networks.

### BACKGROUND

Conventional domain names are generally treated as human-readable labels that resolve to network locations or serve as brand identifiers. Such domain names do not, by themselves, define a behavior-economic namespace, bind a co-owner identity, enforce a deterministic policy container, issue a verifiable receipt, prevent duplicate value recognition, or constrain rollback scope.

Conventional Internet systems route packets and host applications, but they do not provide a common control plane for domain-origin identity, verified time, object-confirmed behavior, policy execution, non-duplication, atomic clearing, index publication, licensing, and bounded remediation.

Conventional Internet economy systems are often platform-centric. Persons are treated as users, subscribers, customers, or participants. Value is typically captured by a platform through accounts, data extraction, advertising, subscription fees, or transaction fees. Such systems do not define a co-owner-origin behavioral-economic value network in which verified life-time behavior events become non-duplicative, receipt-backed, clearable, indexable, licensable, and remediable BEI records.

Existing DNS, DID, blockchain, token, payment, exchange, audit-log, and identity systems may provide individual components. However, they do not provide the present domain-origin BEI Internet Economy passage: a network-domain basepoint that binds BEI co-owner identity, Time-of-Time evidence, object confirmation, deterministic policy execution, non-duplication control, BEIMINT/ATMS value output, RRec/ACR finality, BEIIndex/BEIMarket routing, and BEIFR2/BEIClawback bounded correction.

### SUMMARY OF THE INVENTION

The invention provides a domain-origin technical control architecture for network naming, Internet control-plane operation, and behavioral-economic value-state processing. First, a network domain name is caused to operate as an active domain-origin basepoint that binds namespace scope, identity endpoint, policy endpoint, evidence admission, value routing, and bounded remediation scope. Second, the Internet is implemented as a BEI domain-origin control plane that executes deterministic policy containers and emits proof-carrying artifacts including RRec, Marker, ACR, and RBP. Third, Internet Economy functions are implemented as a BEI co-owner behavioral-economic value-state network in which verified life-time behavior events are converted into non-duplicative, policy-gated, receipt-backed, atomically cleared, indexable, licensable, and bounded-remediable BEI value records.

A verified BEI event may bind a BEI co-owner identity, a domain-origin basepoint, a Time-of-Time coordinate, an object reference, a behavior-event type, an evidence hash, a policy-container identifier, and a non-duplication reference. The event may be represented as a BEI-TVP record, an intent envelope, or a fission-root record and may be routed through domain-origin functional nodes including ATMS, BEIMINT, BEIMINTING, MF, BEI Currency, TimeCurrency, BEIGX, BEIIndex, and BEIMarket nodes.

The resulting records may include RRec verifiable receipts, tri-header receipts, BEI-TVP records, fission-root records, derivative records, TimeCurrency units, BEI Currency units, allocation records, atomic clearing records, finality markers, index records, license records, royalty-basis records, grant records, asset-package diligence records, and bounded correction dependencies.

The system improves computer and network operation by canonicalizing inputs, executing policy in a deterministic sandbox, emitting proof-carrying artifacts, limiting duplicate value recognition, coordinating atomic clearing across heterogeneous rails, detecting downgrade or conflict states, and generating bounded rollback proofs constrained by time-domain and impact-scope boundaries.

### Redefinition and Invention of Domain Name, Internet, and Internet Economy

### Redefined Domain Name

In the present disclosure, a domain name operates beyond a passive address-resolution label as an active domain-origin infrastructure node. The domain-origin node defines a namespace scope, binds a BEI co-owner identity endpoint, selects or references a policy container, admits evidence, emits proof-carrying receipts, routes value records, and constrains remediation.

A BEI domain name may be implemented as a Domain Basepoint Node (DBN), machine-resolvable namespace anchor (MNA), domain-origin basepoint, domain parcel, sovereign parcel, BEI Land, BEI Lot, curated root, delegated subdomain, or equivalent namespace scope. The claim scope is not limited to a specific top-level domain or DNS implementation so long as the identifier supplies a verifiable namespace boundary, policy authority, and evidence-routing function.

The domain-origin basepoint may support a Treasure Bowl/Virgin Land mode, in which a curated root can spawn bounded sub-scopes, terminal territories, branch nodes, store nodes, franchise nodes, industry cells, jurisdiction cells, or time-domain cells, each controlled by policy containers and proof-carrying artifacts.

### Redefined Internet

The BEI Internet is implemented as a domain-origin control plane in which domain basepoint nodes, BEI co-owner identity endpoints, deterministic policy containers, proof-carrying artifacts, atomic clearing records, finality markers, verifier reconstruction data, and bounded remediation proofs cooperate to govern behavioral-economic state transitions across heterogeneous networks.

Unlike a conventional packet-routing network or platform-hosted application stack, the BEI Internet processes identity, time, behavior, evidence, policy, receipt, finality, rollback, index, and licensing records. It may operate across DNS, DID, registry, ledger, financial rail, application, IoT, medical, and enterprise systems through adapter profiles and standards-profile negotiation.

A standards-profile negotiation result may include MATCH, NEGOTIATED, FALLBACK, or INCOMPATIBLE status. If downgrade_detected is true, the control plane may gate FINAL status, emit a CONFLICT marker, freeze affected transitions, and route the matter to bounded remediation before value is released or relied upon.

### Redefined Internet Economy

The BEI Internet Economy is implemented as a domain-origin co-ownership value-state network rather than a platform-centric extraction model. BEI co-owners and co-developers are not merely users, subscribers, customers, or participants; they are origin nodes of behavior-time evidence and value-state transitions within a policy-governed Internet economy infrastructure.

A BEI Internet Economy may convert object-confirmed life-time behavior events into non-duplicative, policy-gated, receipt-backed, atomically cleared, indexable, licensable, and bounded-remediable BEI value records. Such records may be routed through ATMS, BEIMINT, MF, BEI Currency, TimeCurrency, BEIGX, BEIIndex, BEIMarket, and related functional nodes.

The BEI Internet Economy may generate multiple derivative outputs from one root event, including a receipt, TimeCurrency unit, BEI Currency unit, health grain, clearing record, settlement record, reserve record, index value, license-use record, royalty-basis record, grant record, object-life certification, valuation-evidence record, and asset-package diligence record. A Non-Duplication Controller prevents prohibited duplicate minting, clearing, indexing, licensing, royalty recognition, transfer, grant allocation, and asset-package inclusion.

### Definitions

| Term | Definition |
|---|---|
| BEI | Behavioral Economic Identity or |
| | Behavioral-Economics Identity, including |
| | identity, behavior, time, evidence, value, |
| | policy, and correction state associated |
| | with a co-owner node. |
| BEI co-owner/ | A person, family, institution, enterprise, |
| co-developer | device, industry node, or jurisdictional |
| | node that acts as an originating |
| | component of the BEI economy, not |
| | merely as a platform user. |
| DBN/Domain | A programmable infrastructure node |
| Basepoint Node | associated with a domain-origin |
| | namespace anchor, policy endpoint, key |
| | authority, evidence-routing function, and |
| | remediation scope. |
| BEI-TVP | A BEI time-value-packet or time-value |
| | proof record that binds identity, time, |
| | behavior, object, evidence, policy, and |
| | non-duplication data. |
| Fission Root | A root record for a life-time behavior |
| Record | event, including root ID, identity anchor, |
| | domain origin, time window, evidence |
| | hash, policy container, non-duplication |
| | hash, output eligibility, correction state, |
| | correction dependency, and audit anchor. |
| Object | Machine-verifiable binding of a behavior |
| Confirmation | event to a real or digital object, |
| | counterparty, service, device, record, or |
| | condition. |
| RRec | A verifiable receipt binding namespace, |
| | identity, intent or event digest, policy |
| | digest, evidence or attestation digest, |
| | replay-prevention value, timestamp or |
| | time coordinate, audit commitment, and |
| | signature bundle. |
| ACR | An atomic clearing record binding a |
| | clearing-intent digest, rail or ledger set, |
| | finality proof set, commit timestamp, |
| | resulting state digest, and signature or |
| | quorum bundle. |
| Marker | A reconciliation artifact indicating |
| | FINAL, CONFLICT, REJECT, FROZEN, |
| | or remediation state for a transition. |
| RBP | A rollback proof binding a prior state |
| | digest, rollback target digest, new state |
| | digest, dependency digest set, reason |
| | code, bounded window, impact scope, |
| | audit-chain linkage, and signature bundle. |
| Non-Duplication | A module that prevents or limits duplicate |
| Controller | minting, clearing, indexing, licensing, |
| | royalty recognition, transfer, grant |
| | allocation, and asset-package inclusion. |
| BEIMINT/MF | Minting or monetary-factory functional |
| | nodes that convert validated BEI-TVP, |
| | TimeGR, BEI-GR, fission-root, or receipt |
| | records into authorized value outputs. |
| ATMS | Assets-Time-Mint/Money-Service/System |
| | layer that processes assets, time, currency, |
| | clearing, service, and system records. |
| BEIGX/BEICX/ | Exchange, clearing, standards/securities, |
| BEISX/BEIMarket | and market/licensing nodes for transfer, |
| | authorization, settlement, listing, |
| | valuation, and asset-package routing. |
| BEIIndex | Index publication layer that computes |
| | personal, family, industry, jurisdictional, |
| | global, time-behavior, and asset-package |
| | index outputs from verified BEI records. |

### System Overview

Domain-Origin Resolver: Resolves DBN/MNA/domain-origin basepoint, namespace_id, catalog_version, catalog_digest, scope token, and policy endpoint.

BEI Identity Kernel: Resolves BEI co-owner identity endpoint, BEIDID, alias-to-immutable mapping, lifecycle status, delegated keys, and recognition level.

Time-of-Time Module: Binds machine timestamp, TimeGR, BEI-GR, service period, life-time window, time-domain coordinate, and time attestation.

Object Confirmation Engine: Links event to object reference, service proof, device attestation, medical record, transaction object, or domain asset.

BEI-TVP/Fission Root Generator: Generates the BEI event root with evidence hashes, policy references, non-duplication references, output eligibility, and correction dependency.

Deterministic Policy Kernel: Canonicalizes inputs and executes policy containers in deterministic sandbox using risk, compliance, privacy, identity, time, and value predicates.

Proof Artifact Service: Emits RRec, THR, Marker, ACR, RBP, NonDuplicationReceipt, index publication receipt, license-use record, and asset-package diligence record.

BEIMINT/ATMS Output Engine: Routes eligible records to minting, currency lifecycle, TimeCurrency, savings, collateral, loan, allocation, or settlement modules.

Exchange/Index/Market Layer: Routes records to BEIGX, BEICX, BEISX, BEIMarket, BEIIndex, licensing, royalty, grant, and portfolio-data-room outputs.

BEIFR2/BEIClawback Engine: Computes dependency graph, blast radius, time-domain boundary, impact scope, patch set, supervisory receipt, RBP, and correction markers.

### Data Structures

| Record | Minimum Fields | Primary Function |
|---|---|---|
| BEI-TVP | identity_anchor; | Converts a behavior-time |
| | domain_origin_id; | event into a verifiable BEI |
| | time_coord; object_ref; | value packet. |
| | behavior_type; | |
| | evidence_digest; | |
| | policy_container_id; | |
| | non_duplication_ref; | |
| | correction_dependency | |
| Fission Root | fission_root_id; | Roots one life-time |
| | identity_anchor; | behavior event and controls |
| | domain_origin_id; | derivative outputs. |
| | time_window; | |
| | evidence_hash; | |
| | policy_container_id; | |
| | non_duplication_hash; | |
| | eligibility_profile; | |
| | correction_state; | |
| | audit_anchor | |
| RRec | namespace_id; subject_id; | Proof-carrying receipt for |
| | intent_digest; | external recomputation. |
| | policy_digest; | |
| | attestation_digest; | |
| | replay_value; timestamp; | |
| | audit_commitment; | |
| | signature_bundle | |
| THR | identity_header; | Tri-header receipt linking |
| | behavior_header; | identity, behavior, and |
| | economic_header; | economic state. |
| | content_id; MNA anchor; | |
| | signature_bundle | |
| ACR | clearing_intent_digest; | Atomic finality across |
| | rail_set; prepare_proof_set; | heterogeneous settlement |
| | commit_proof_set; | systems. |
| | finality_proof_set; | |
| | resulting_state_digest | |
| Marker | transition_id; marker_type; | FINAL/CONFLICT/REJECT/ |
| | reason_code; | FROZEN status for a |
| | proof_reference; | transition. |
| | namespace_id; time_coord; | |
| | signature_bundle | |
| RBP | prior_state_digest; | Bounded remediation with |
| | rollback_target_digest; | audit-preserving rollback |
| | new_state_digest; | proof. |
| | dependency_digest_set; | |
| | bounded_window; | |
| | impact_scope; | |
| | patch_set_digest | |
| Asset-Package Record | claim_element_id; | Maps patent support to |
| | module_id; | licensing and transfer |
| | domain_asset_ref; | assets. |
| | trademark_ref; API_ref; | |
| | SKU_ref; license_field; | |
| | revenue_basis; | |
| | evidence_pointer | |

### Domain-Origin Processing Flow

Step 1: Receive a life-time behavior event, transaction intent, service event, medical event, IoT event, communication event, banking event, domain parcel event, or licensing event.

Step 2: Resolve a domain-origin basepoint, DBN, MNA, sovereign parcel, or domain-scope identifier.

Step 3: Resolve the BEI co-owner identity endpoint and any delegated key, alias, role, jurisdiction, family, institution, industry, device, or jurisdictional node relationship.

Step 4: Bind Time-of-Time evidence, TimeGR, BEI-GR, time attestation, start/end time, service period, or time-domain coordinate.

Step 5: Perform object confirmation and bind object reference, service proof, counterparty evidence, device attestation, medical evidence, title object, or transaction object.

Step 6: Canonicalize the event or intent envelope and compute intent_digest, event_digest, evidence_digest, and policy selection digest.

Step 7: Execute a deterministic policy container and evaluate identity, risk, compliance, privacy, time, evidence, non-duplication, minting, clearing, licensing, and remediation predicates.

Step 8: Generate a BEI-TVP or fission-root record if admission criteria are met.

Step 9: Pass the root record through a Non-Duplication Controller before minting, clearing, indexing, licensing, royalty recognition, transfer, grant allocation, or asset-package inclusion.

Step 10: Route eligible records to ATMS, BEIMINT, MF, BEICurrency, TimeCurrency, BEIGX, BEICX, BEISX, BEIIndex, BEIMarket, or other functional nodes.

Step 11: Generate RRec, THR, ACR, FinalityMarker, index publication receipt, license-use record, royalty-basis record, and asset-package diligence record as applicable.

Step 12: Upon conflict, downgrade, drift, duplication, error, fraud, or dispute, emit CONFLICT or FROZEN marker, compute impact report, generate RBP, execute BEIFR2/BEIClawback within time-domain and impact-scope boundaries, and preserve append-only audit trail.

### Multi-Object-Confirmation Bei Internet Economy Graph

In some embodiments, the BEI Internet Economy is implemented as a multi-object-confirmation behavioral-economic identity graph. A verified event may bind a BEI co-owner identity, a domain-origin basepoint, a Time-of-Time coordinate, an object reference, a behavior type, an evidence hash, a policy container identifier, and a non-duplication reference.

The graph may include dependency edges among identity nodes, domain nodes, object nodes, time nodes, industry nodes, need nodes, currency nodes, clearing nodes, index nodes, license nodes, royalty nodes, and asset-package nodes. Edges may be typed as identity-domain, identity-time, identity-object, object-evidence, event-policy, event-currency, event-clearing, event-index, event-license, and correction-dependency edges.

The graph may route verified BEI-TVP or fission-root records through domain-origin functional nodes including ATMS.com for asset-time-money-service processing, BEIMINT.com or BEIMINTING.com for minting authorization, MF.app as a mint or monetary factory endpoint, BEICurrency.com for BEI Currency lifecycle management, TimeCurrency endpoints for time-denominated value records, BEIGX.com for exchange and licensing, BEIIndex.com for index publication, and BEIMarket for asset-package transaction routing.

### BEIMINT, ATMS, Currency, Exchange, and Index Layers

A BEIMINT node validates that a BEI-TVP, TimeGR, BEI-GR, Fission Root, RRec, or verified receipt bundle satisfies policy predicates before issuing BEI Currency units, TimeCurrency units, allocation records, lifecycle records, non-fungible behavior records, or minting certificates.

An ATMS node processes assets, time, mint/money, service, and system records. In some embodiments, ATMS includes identity-bound account provisioning, issuance, transfer, clearing, reconciliation, dispute/chargeback callback, collateral, savings, lending, insurance, and treasury modules. A value state may remain LOCKED until risk predicates are satisfied and a FINAL marker is issued, and may move to FROZEN or REMEDIATION on conflict.

BEI Currency units may be bound to verified behavioral-economic evidence. TimeCurrency units may be bound to verified time attestations, Time-of-Time coordinates, service intervals, labor records, caregiving records, learning records, creative records, or medical-health time events. Both may share deterministic policy gates, RRec receipts, ACR finality, non-duplication control, and BEIFR2 remediation.

BEIGX, BEICX, BEISX, BEIMarket, and BEIIndex nodes may process exchange, clearing, standards/securities, market licensing, index publication, data-room, asset-package, royalty, and grant records. An index value may be computed from aggregated proof-carrying artifacts and bound to an index publication receipt with a hash-chain or audit-chain anchor.

### Non-Duplication, Beifr2, and BEIClawback

The Non-Duplication Controller prevents or limits prohibited duplicate minting, clearing, indexing, licensing, grant allocation, royalty recognition, transfer, and asset-package inclusion. It may compare identity anchor, domain origin, time window, object reference, event type, evidence hash, policy identifier, prior derivative records, authorized reuse flags, and correction state.

BEIFR2 bounded remediation differs from ordinary reversal and from immutable ledger finality. It computes a dependency graph, blast radius, affected record set, patch set, time boundary, impact boundary, and authority or supervisory receipt. The remediation engine preserves prior audit commitments while creating corrective entries and rollback proofs.

BEIClawback may propagate correction from a derivative record back to a fission root, license record, royalty-basis record, index record, clearing record, grant record, asset-package inclusion record, or currency lifecycle record. A correction may freeze, reverse clear, remint, re-index, adjust license scope, adjust royalty basis, or update asset-package valuation evidence within permitted boundaries.

### Asset Package, Licensing, and Valuation Support

The system may generate a Claim-to-SKU-to-Domain-to-BEIMarket map. Such a map links claim elements, patent family records, domain assets, trademarks, APIs, software modules, NeedPacks, IndustryPacks, jurisdiction packs, currency records, clearing records, index records, license fields, royalty-basis records, and asset-package diligence records.

The asset-package layer is a technical output layer, not a valuation promise. It creates machine-readable evidence for due diligence, licensing, transfer, royalty accounting, revenue sharing, infringement mapping, portfolio segmentation, and cross-vertical deployment.

Representative SKUs include BEIDBN-SCOPE, BEITVP-FISSION, BEINONDUP, BEIMINT-MF, ATMS-SETTLE, BEICURRENCY-LIFE, TIMECURRENCY-TOT, BEIGX-LIC, BEIINDEX-VAL, BEIFR2-RBP, and BEIMARKET-PACK. Each SKU may be tied to claim elements, figure references, module IDs, domain-origin functional nodes, and licensing fields.

### Anti-Rejection Support and Technical Effects

Section 112 support is provided through explicit definitions, field structures, state transitions, data objects, processing flows, failure states, figure descriptions, and claim-to-module mapping. Terms such as DBN, BEI-TVP, Fission Root, RRec, ACR, Marker, RBP, Non-Duplication Controller, BEIMINT, ATMS, TimeCurrency, BEI Currency, BEIFR2, and BEIMarket are described as data structures and computer-executed modules, not merely as labels.

Section 101 technical character is supported because the invention is directed to computer-network infrastructure improvements including deterministic canonicalization, policy-container execution in a sandbox, proof-carrying receipts, atomic clearing records, finality markers, non-duplication gates, bounded remediation proofs, external verifier reconstruction, and adapter-mediated interoperability across heterogeneous systems.

Sections 102 and 103 distinctions are supported because the invention is not merely DNS, DID, blockchain, payment clearing, token minting, AI scoring, or a super-app. The inventive passage combines domain-origin basepoint resolution, BEI co-owner identity, Time-of-Time evidence, object-confirmed fission-root generation, deterministic policy execution, non-duplication control, receipt-backed minting, atomic finality, index/licensing routing, and BEIFR2/BEIClawback bounded remediation as an integrated necessary channel.

The invention improves computer operation by reducing semantic drift, replay, duplicate value recognition, cross-domain finality mismatch, unbounded rollback risk, non-verifiable operator discretion, audit ambiguity, downgrade attacks, privacy leakage, and asset-package due diligence uncertainty.

### Technical Problems, Technical Solutions, and Technical Effects

A first technical problem is duplicate value recognition across heterogeneous systems. Conventional DNS, identity, payment, ledger, marketplace, and audit systems may each maintain separate state, such that a behavior event may be recognized more than once for minting, clearing, indexing, licensing, grant allocation, royalty recognition, transfer, or asset-package inclusion. The present system solves this problem by binding identity anchor, domain-origin identifier, time window, object reference, behavior-event type, evidence digest, policy identifier, derivative graph reference, authorized-reuse flag, and correction state into a non-duplication controller before value routing. The technical effect is machine-enforced prevention, limitation, quarantine, or authorized-reuse marking of duplicate outputs before finality is issued.

A second technical problem is cross-domain finality mismatch. A first ledger, rail, registry, marketplace, or enterprise system may treat a record as final while another system retains a pending, conflict, revoked, or downgraded state. The present system solves this problem by generating RRec receipts, atomic clearing records, finality markers, selected standards-profile digests, and verifier reconstruction data. The technical effect is that an external verifier may recompute artifact digests, replay policy predicates, compare finality states, and reject mismatched or downgraded transitions rather than relying on unverified operator assertions.

A third technical problem is unbounded rollback or uncontrolled correction cascade. Conventional reversal or immutable-ledger designs may either fail to correct bad derivatives or overcorrect unrelated records. The present system solves this problem through BEIFR2 or equivalent bounded remediation that computes a dependency graph, bounded blast radius, affected record set, time-domain boundary, impact-scope boundary, patch-set digest, supervisory authorization receipt, rollback proof, and correction markers. The technical effect is preservation of unaffected finality outside the impact boundary while allowing auditable correction of affected derivatives.

A fourth technical problem is domain-origin authority drift. A domain, DID, registry, manifest, policy endpoint, or service-binding record may be transferred, migrated, delegated, expired, or downgraded without preserving continuity of authority. The present system solves this problem by binding a domain-origin basepoint to catalog digest, scope token, policy digest, key profile, standards-profile identifier, transition receipt, and audit anchor. The technical effect is continuity proof for domain-origin economic actions and rejection or conflict marking when the namespace or policy authority drifts.

A fifth technical problem is asset-package diligence uncertainty. Conventional licensing packages often require manual claim charts and non-verifiable spreadsheets that do not bind claim elements to generated artifacts. The present system solves this problem by emitting claim-to-SKU, domain-asset mapping, trademark mapping, API mapping, proof-artifact mapping, license-field mapping, royalty-basis mapping, and data-room evidence pointers as machine-readable records. The technical effect is structured diligence, licensing, royalty accounting, portfolio segmentation, and enforcement mapping derived from generated system artifacts.

Observable technical effects may be measured by implementation metrics including duplicate-acceptance count, replay-rejection count, finality-mismatch count, downgrade-detection count, rollback affected-record count, unaffected-finality preservation count, verifier-reconstruction failure count, and manual diligence-field reconciliation count. The invention does not require a fixed percentage improvement in every deployment; rather, the technical effect is produced by the enforced data structures and state gates that convert otherwise discretionary or non-verifiable actions into recomputable, receipt-backed, and bounded state transitions.

In one comparative test configuration, a baseline system lacking a domain-origin basepoint, NonDuplicationReceipt, ACR, and RBP may be operated with the same candidate event stream. The present system rejects or marks as CONFLICT events having duplicate candidate hashes, mismatched standards-profile digests, stale policy versions, invalid object references, or exceeded remediation boundaries, and records the reason code and proof pointer for independent verification.

### Verifier Reconstruction and Proof Sample Embodiment

In a verifier reconstruction embodiment, an external verifier receives or retrieves a proof-carrying artifact package containing namespace_id, subject_id, schema_version, canonicalization_rule_id, policy_container_id, selected_standards_profile_digest, event_digest, evidence_digest, non_duplication_reference, RRec digest, ACR digest, finality marker, correction_state, and optional rollback proof reference. The verifier reconstructs canonical bytes from the referenced fields, recomputes at least one digest, replays the policy container or verifies a policy decision digest, checks the non-duplication receipt, compares the ACR state and finality marker, and outputs ACCEPT_FINAL, ACCEPT_LIMITED, CONFLICT, REJECT, or REMEDIATION_REQUIRED. A mismatch between recomputed digest and artifact digest causes the verifier to mark the transition CONFLICT or REJECT and prevents reliance on FINAL status until remediation is completed.

### Needpacks, Industrypacks, and Examples

Medical and Health embodiment: A medicalcenter.us or 120.us node may bind patient consent, provider attestation, clinical evidence, health grain records, medical time tunnel, payer adjudication, health-value clearing, and bounded correction.

Financial and Banking embodiment: An ATMS node may bind BEIDID, account/wallet provisioning, issuance, transfer, clearing, reconciliation, KYC/AML predicate checks, ISO 20022 adapter mapping, and ACR finality.

Telecom and Digital Entrance embodiment: A BEI Grid or terminal node may transform calls, messages, QR codes, login requests, IoT events, or AI-agent requests into digital entrance events controlled by SWITCH_CODE, SceneKey, Silent Echo Signature, and BEIFR2 recovery.

Domain Parcel and Franchise embodiment: A root domain may spawn sub-parcels, store nodes, franchise nodes, branch nodes, NameNFT/StoreNFT/FranchiseNFT records, and license packages under policy-governed co-stewardship.

IoT and Real Estate embodiment: A GOK or object key may bind physical assets, IoT sensor measurements, title/lease/mortgage status, minute feeds, RRec status, and settlement records.

Government and Jurisdiction embodiment: A jurisdictional DBN may compute BEI reserve metrics, BEI GDP-style metrics, social impact indices, public benefit invariants, and standards-profile conformance receipts.

### Industrial Deployment Embodiments

Permissioned-ledger and enterprise-hybrid deployment: in one embodiment, a domain-origin basepoint publishes a signed manifest that identifies a policy-container image digest, schema version, standards-profile digest, and verifier endpoint. A permissioned ledger, enterprise database, or EVM-compatible execution runtime may store RRec, ACR, finality marker, and rollback-proof references, while raw evidence remains in an enterprise evidence repository. The policy container receives canonical event bytes, evaluates identity, time, object, risk, privacy, non-duplication, clearing, and remediation predicates, and writes a deterministic decision digest to the proof-artifact service. When a downstream ledger or database reports a conflicting state, the BEIFR2 engine computes the affected derivative set and generates a bounded rollback proof without requiring a full-network fork.

Cloud-native and edge-control deployment: in another embodiment, DBN resolution, scope-token verification, policy selection, and RRec issuance may be implemented by distributed server-side services, edge workers, message queues, or containerized microservices. Each edge node loads the same canonicalization rules and policy-container digest, accepts only signed scope tokens within an effective time window, rejects downgrade-detected adapter offers, and writes a receipt digest to an append-only log. This permits low-latency processing of domain-origin events while preserving external verifier reconstruction across heterogeneous edge locations.

Trusted-execution and hardware-attested deployment: in another embodiment, the deterministic policy container executes inside a trusted execution environment, secure enclave, hardware security module, or hardware-backed attestation service. The enclave or attested service receives canonical event bytes and evidence digests, signs a policy decision digest, and releases only selective-disclosure outputs or zero-knowledge proof references. The resulting RRec or ACR binds the attestation digest so that a verifier may confirm that identity, privacy, compliance, non-duplication, and remediation predicates were evaluated inside a protected execution boundary.

Financial-rail and ISO-style clearing deployment: in another embodiment, an ATMS or asset-time settlement node maps canonical intent envelopes to external clearing messages, including bank core, ACH, RTGS, RTP, SWIFT-compatible, card, token-ledger, or ISO 20022-style messages. The standards-profile negotiation compares the selected proof requirement against the adapter offer. If the adapter cannot satisfy the selected profile, the system emits a CONFLICT or HOLD marker, prevents FINAL status, and generates a remediation directive or reversal instruction while preserving the domain-origin audit chain.

Medical, IoT, and AI-agent entrance deployment: in another embodiment, a medical endpoint, IoT endpoint, or AI-agent entrance endpoint supplies object references, device attestations, consent records, scene keys, switch codes, silent-echo signatures, or sensor evidence digests. The Non-Duplication Controller compares prior identity, time, object, evidence, and derivative graph references before allowing minting, clearing, indexing, license recognition, grant allocation, or asset-package inclusion. This prevents duplicate recognition of automated or device-originated events and allows bounded correction when an object state, consent state, or device attestation is later revoked or downgraded.

In an ISO 20022-style adapter embodiment, an ATMS node maps a canonical intent envelope into payment initiation, clearing, confirmation, exception, and reversal message classes. The adapter stores mapping_digest, rail_set, external_reference_set, prepare_proof_set, commit_proof_set, and finality proof_set. When an offered rail cannot satisfy the selected standards profile, the adapter emits RC_DOWNGRADE_DETECTED, RC_FINALITY_MISMATCH, or RC_AUTHORITY_QUORUM_FAILED and prevents FINAL until the proof requirement is met.

In a telecom or AI-agent digital entrance embodiment, SWITCH_CODE, SceneKey, Silent Echo Signature, device attestation, caller or agent identity, session nonce, and time coordinate are canonicalized into an entrance_event_digest. The digest is processed by the Non-Duplication Controller before an AI operator, terminal, or automated agent is permitted to trigger minting, clearing, indexing, license use, or remediation.

### DRAWING DESCRIPTION

FIG. 1 illustrates a redefined domain name as a domain-origin basepoint, including a conventional domain label, DBN/domain-origin basepoint, policy endpoint, root record, value routing, and remediation scope.

FIG. 2 illustrates a redefined Internet as a BEI control plane, including an infrastructure control plane, domain anchors, policy-container kernel, proof-artifact service, adapters or rails, and reconciliation.

FIG. 3 illustrates a redefined Internet Economy value network, including a BEI co-owner event, object confirmation, fission root or BEI-TVP generation, non-duplication gate, BEIMINT or ATMS output, and currency, index, or license routing.

FIG. 4 illustrates a multi-object-confirmation BEI dependency graph linking co-owner event, DBN basepoint, identity anchor, Time-of-Time, object reference, evidence hash, policy identifier, non-duplication reference, derivative graph, and fission root or BEI-TVP.

FIG. 5 illustrates a NeedPack and IndustryPack domain matrix in which medical, finance, education, IoT, health, credit, learning, and object cells are each associated with DBN, policy, and routing functions.

FIG. 6 illustrates DBN resolution and BEI-DEN loading, including receiving a domain, resolving DBN, loading a manifest, selecting policy, emitting scope, returning BEI-DEN, and writing an audit anchor.

FIG. 7 illustrates BEI-TVP and fission-root record fields, including identity, domain-origin, time, object, behavior, evidence, policy, non-duplication, eligibility, correction, audit, and Q-qualified fields.

FIG. 8 illustrates BEIMINT or mint-factory minting authorization flow from eligible event through policy gate, non-duplication gate, mint authorization, allocation, currency unit, and lifecycle record.

FIG. 9 illustrates ATMS asset-time-money-service settlement flow from BEI-TVP or root record through intake, credit or reserve, prepare, commit, ACR, and finality marker.

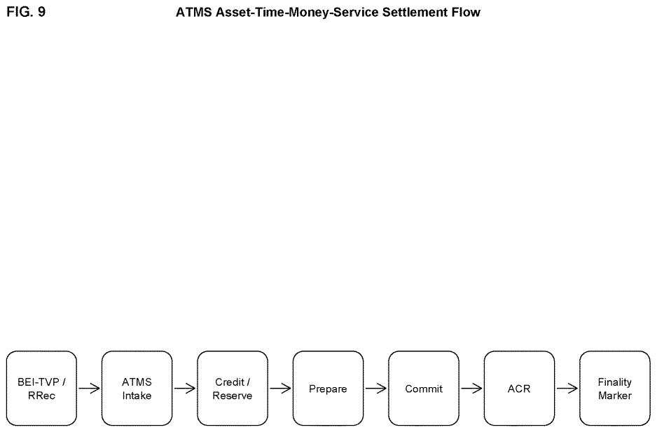

FIG. 10 illustrates RRec, Marker, ACR, and RBP proof-artifact field maps for receipt, state transition, clearing, and bounded rollback evidence.

FIG. 11 illustrates FINAL, CONFLICT, REMEDIATED, REJECTED, and related state-machine transitions for execution, clearing, failure, and remediation.

FIG. 12 illustrates BEIFR2 and BEIClawback bounded remediation including conflict detection, impact computation, boundary limitation, patch set, rollback proof, clawback route, and audit update.

FIG. 13 illustrates a Time-of-Time and TimeCurrency stack comprising Time-of-Time basepoint, TimeGR or BEI-GR, TimeGate, TimeLedger, Time Vault, TimeCurrency unit, and index or settlement output.

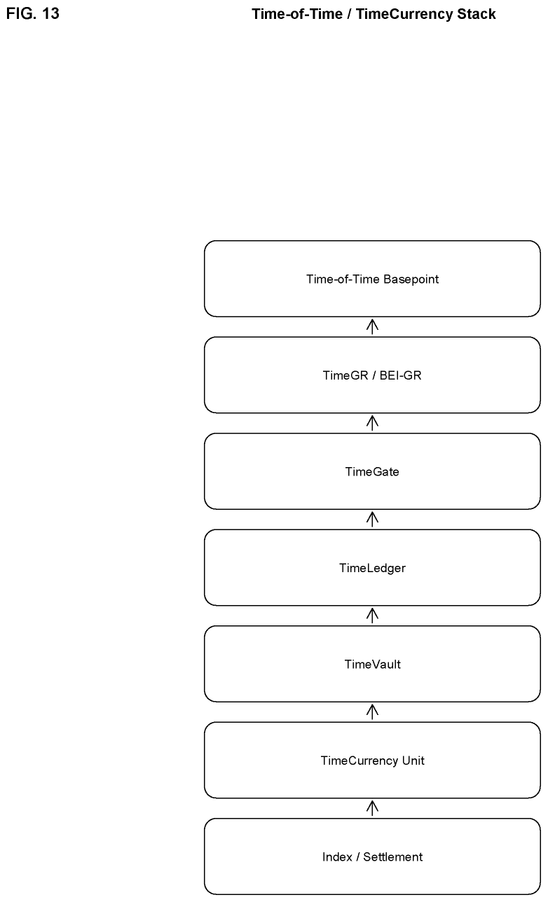

FIG. 14 illustrates a BEI Currency lifecycle including fission root, reserve predicate, unit issuance, transfer, clearing, indexing, burn, and re-indexing.

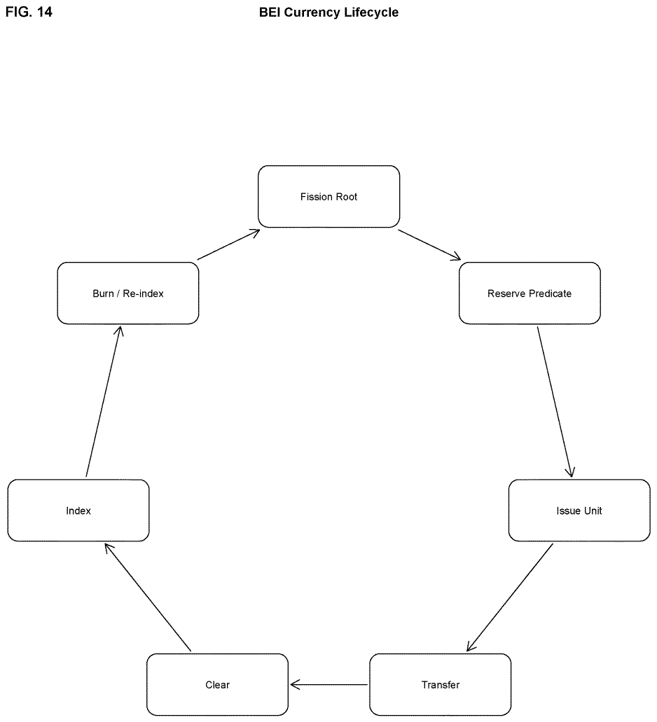

FIG. 15 illustrates claim-to-SKU-to-BEIMarket asset-package mapping across claim elements, patent family, domain asset, trademark, API module, proof artifact, license field, royalty basis, package, and data-room matrix.

FIG. 16 illustrates BEISIGN object confirmation and proof gate from BEI identity, object reference, evidence source, BEISIGN gate, RRec output, and access decision.

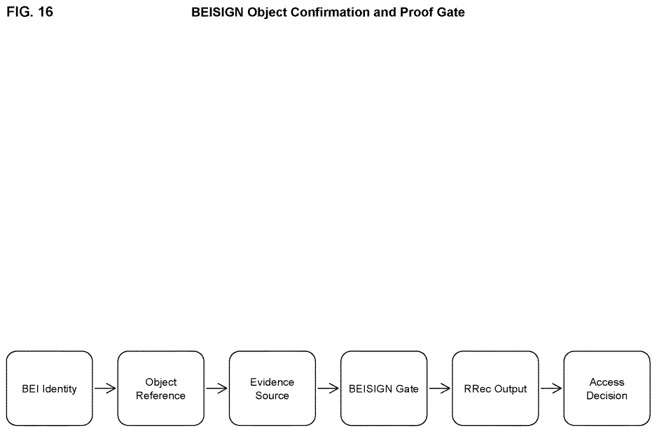

FIG. 17 illustrates BEIIndex publication flow from RRec or ACR through quality weights, correction state, index engine, personal or industry output, jurisdiction output, and publication receipt.

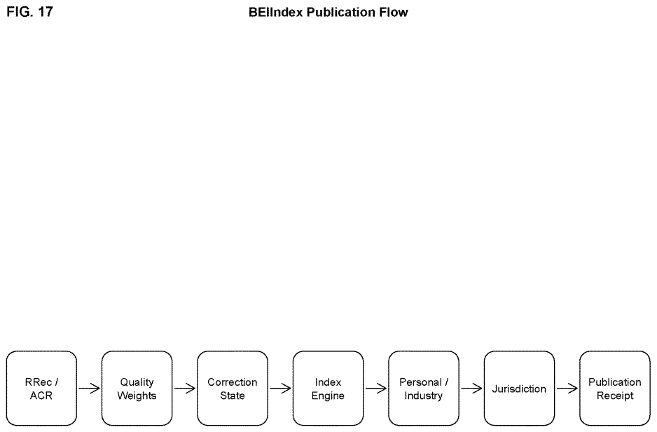

FIG. 18 illustrates BEIGX, BEICX, BEISX, and BEIMarket routing from value record through listing, exchange, clearing, standards, license package, and royalty basis.

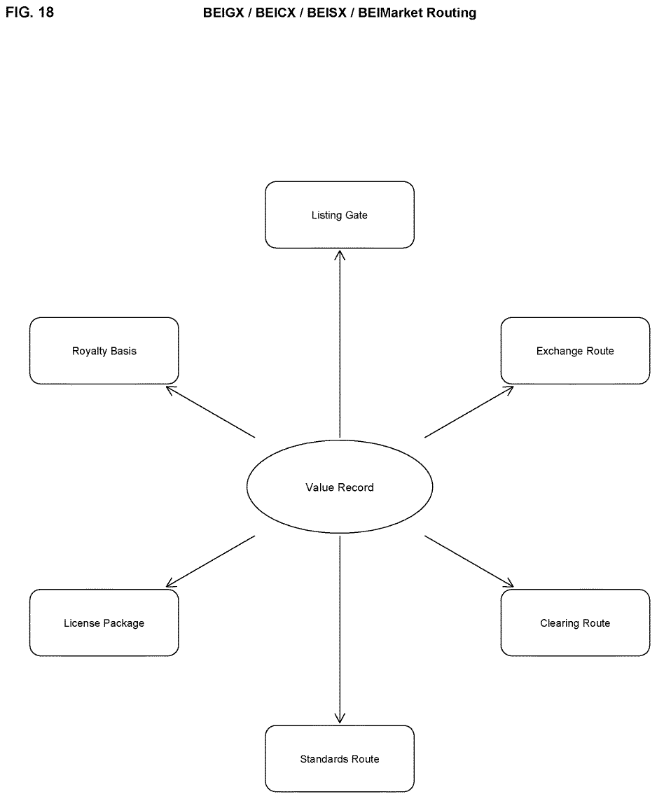

FIG. 19 illustrates a BEI Grid digital entrance trust layer including digital entrance, scope token, SWITCH code, operator or AI gate, policy decision, RRec, and FR2 recovery.

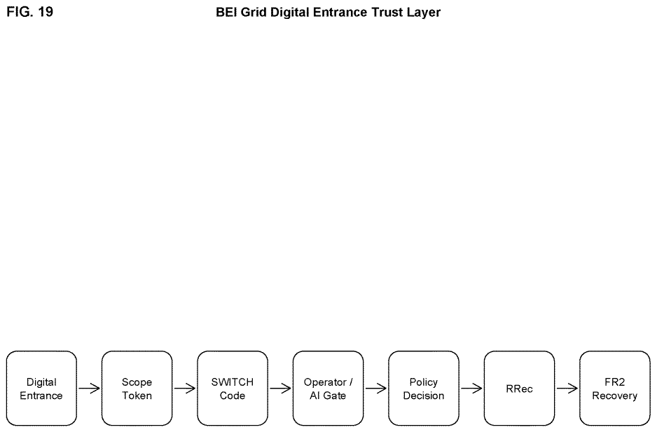

FIG. 20 illustrates a Q-qualified evidence and value layer including qualifier class, quality-of-proof score, object-confirmation grade, time-coordinate quality, policy quality, non-duplication confidence, and audit reproducibility.

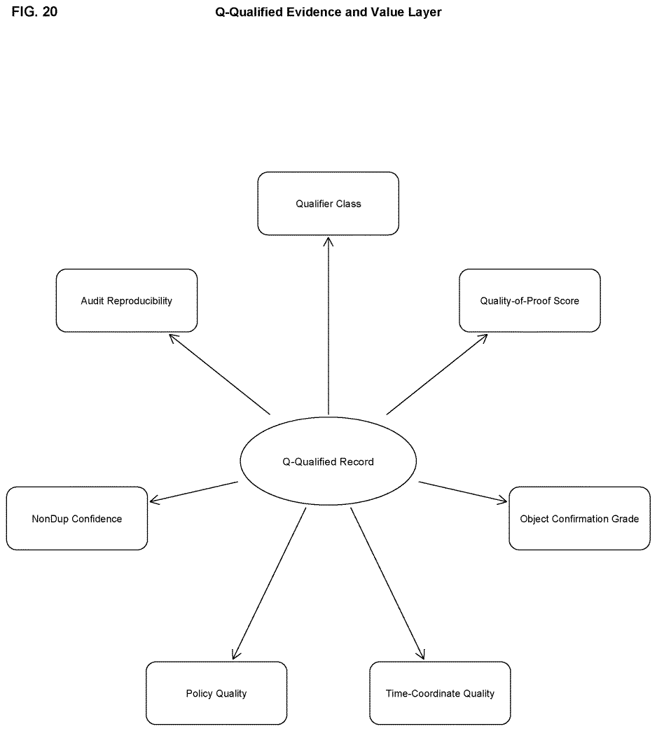

FIG. 21 illustrates qualified-key BEISIGN and rotation receipt, including key profile, credential binding, rotation event, continuity proof, RRec, and audit chain.

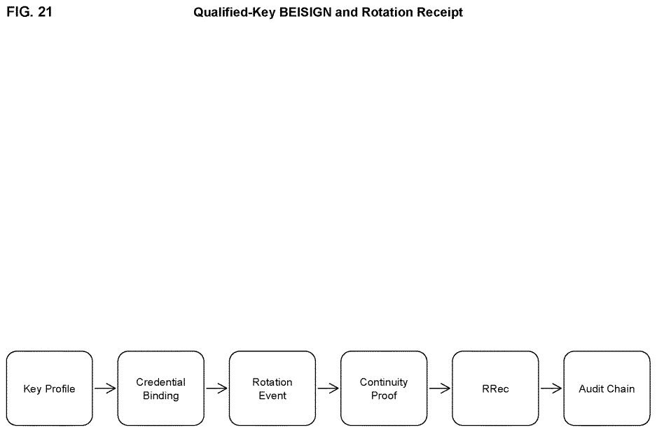

FIG. 22 illustrates privacy-preserving BEIMINT and BEIIndex using raw evidence, selective disclosure, zero-knowledge or MPC proof, policy gate, mint or index output, RRec, and audit.

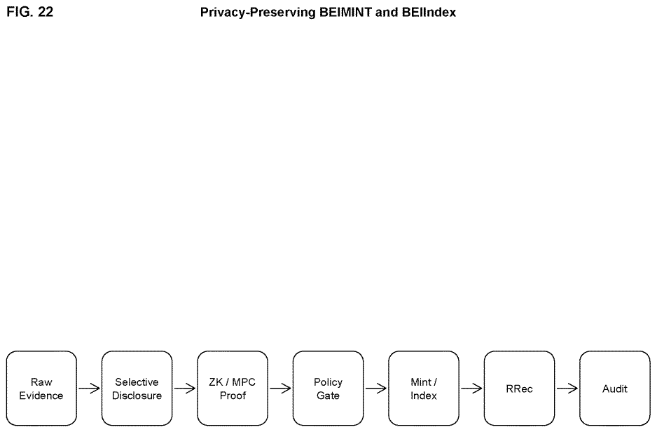

FIG. 23 illustrates a healthcare IndustryPack implementation including medical endpoint, clinical evidence, health grain, time tunnel, resource orchestration, health clearing, and index or grant output.

FIG. 24 illustrates IoT or object-life certification including device endpoint, object key, sensor evidence, policy gate, RRec, title or lease state, and FR2 remediation.

FIG. 25 illustrates borrowing-lending demand-supply event processing including borrow request, lending offer, object confirmation, risk predicate, ATMS settlement, ACR, and index update.

FIG. 26 illustrates a heterogeneous standards-conflict topology in which a domain-origin basepoint interacts with legacy rail, ledger rail, identity rail, medical or IoT rail, adapter offers, selected standards profiles, downgrade detection, CONFLICT gating, and bounded remediation routing.

FIG. 27 illustrates standards-profile negotiation and downgrade handling, including selected profile, adapter offer, baseline comparison, downgrade decision, CONFLICT marker, remediation, and FINAL status.

FIG. 28 illustrates a BEI NetEco domain-origin economy layer connecting BEI.app, BEIECO, BEINETECO.com, ATMS.com, BEIMINT or MF.app, BEIGX or BEIIndex, and BEIMarket.

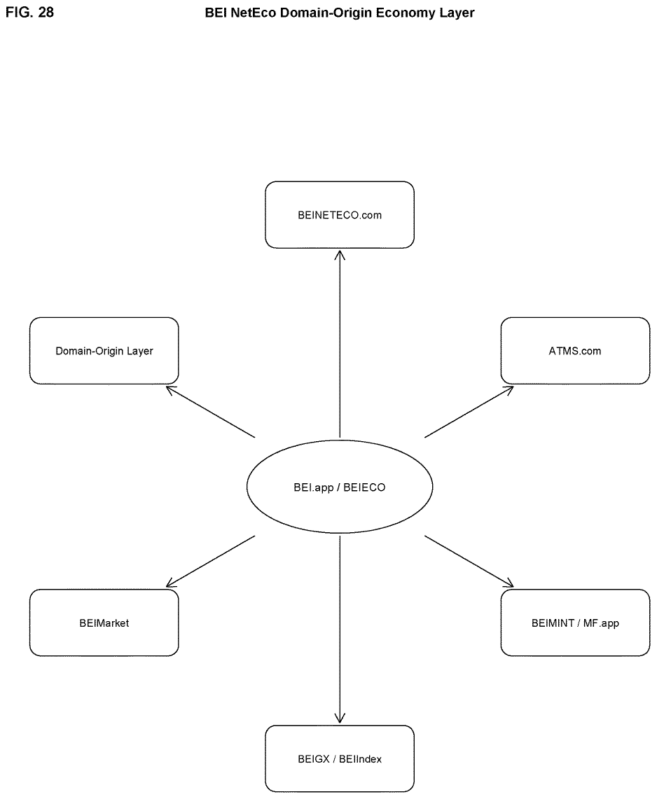

FIG. 29 illustrates a verifier reconstruction workflow in which a verifier requests an artifact, loads rules, recomputes digests, replays policy, verifies proofs, accepts FINAL, or rejects and marks CONFLICT.

FIG. 30 illustrates a royalty-basis and data-room valuation flow in which claim elements are mapped to technical SKUs, usage meters, license fields, royalty bases, BEIMarket packages, diligence evidence pointers, and transfer records.

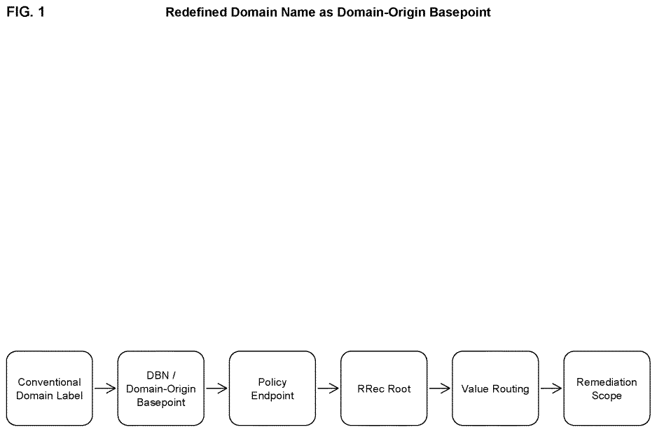

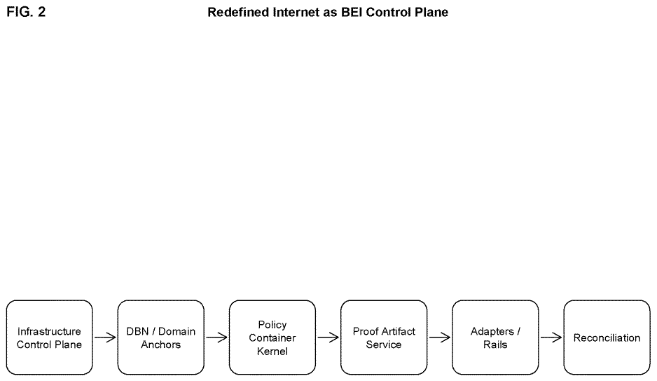

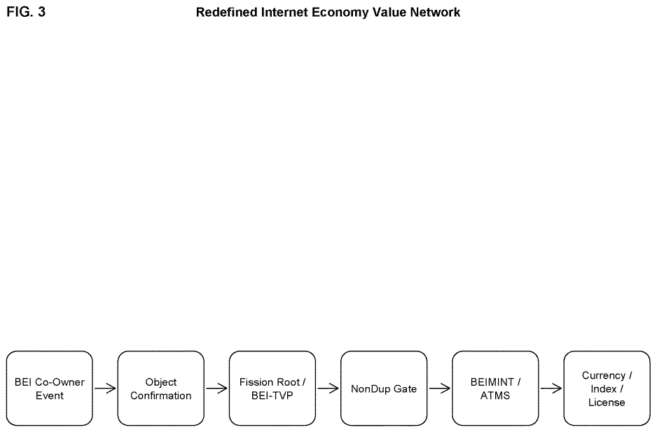

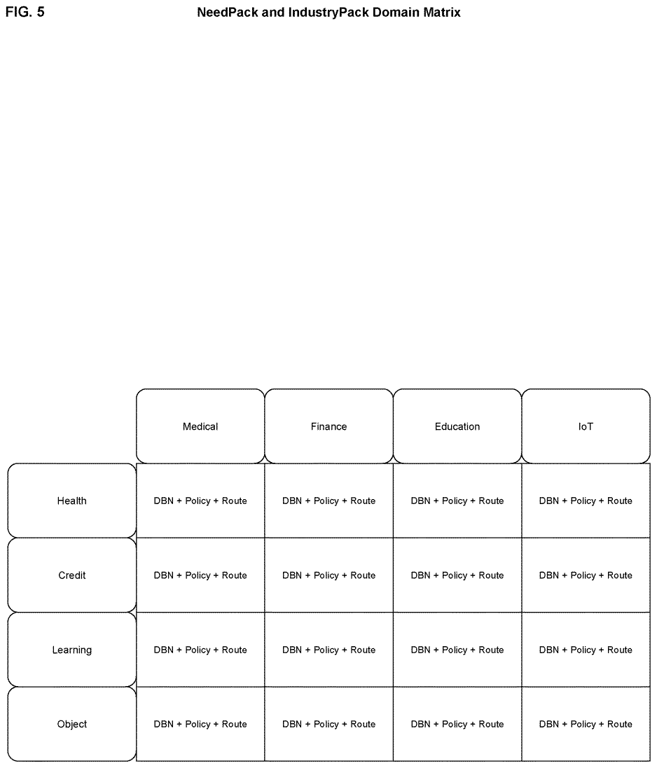

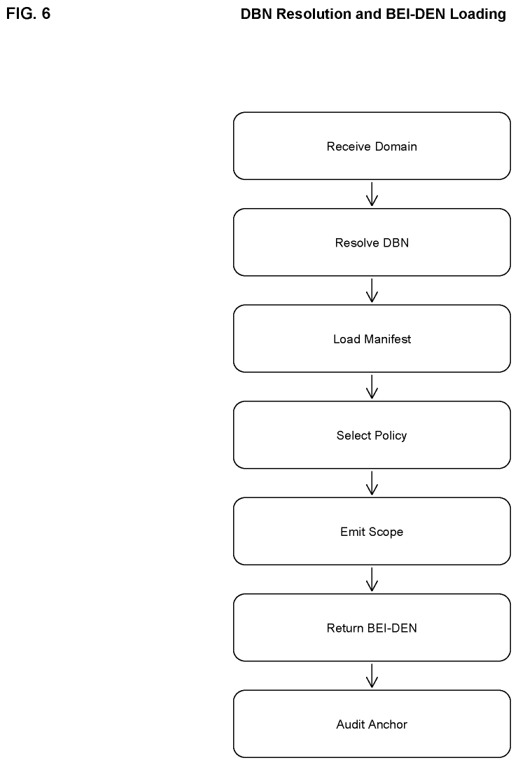

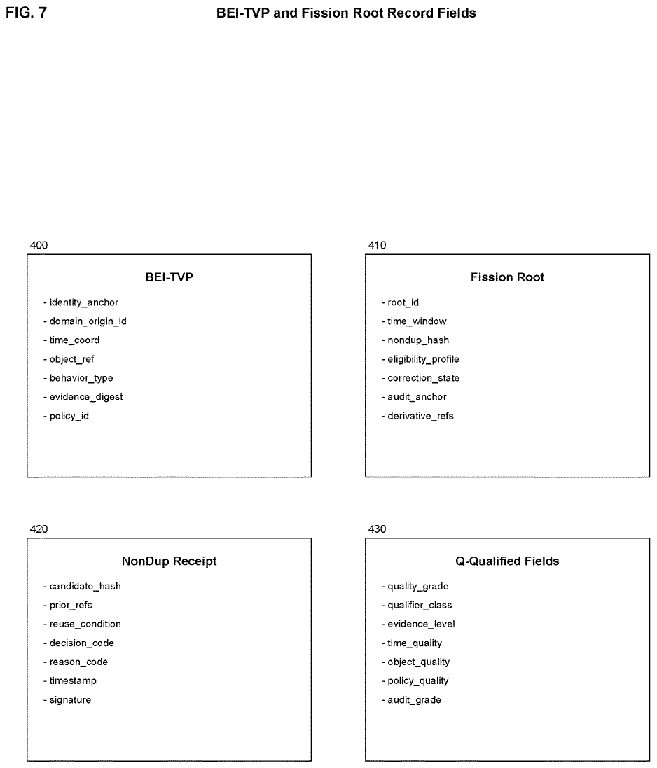

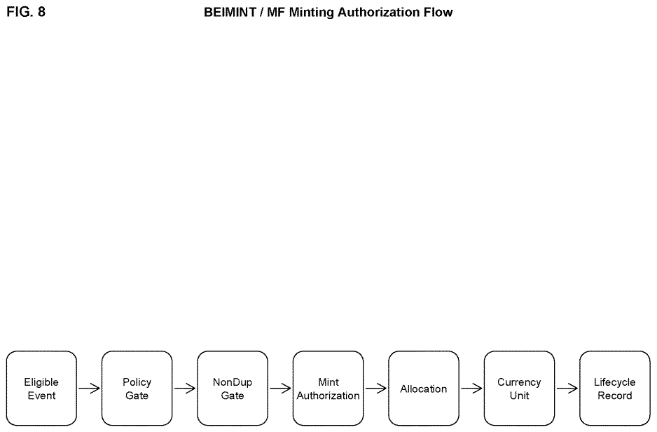

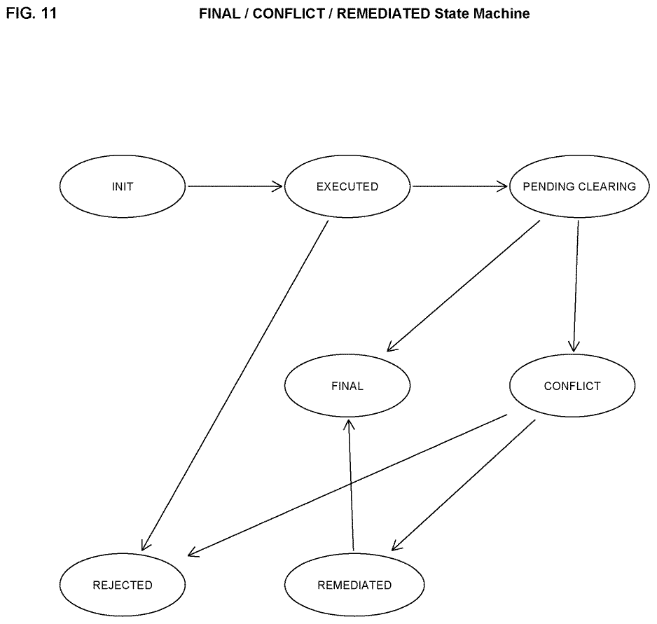

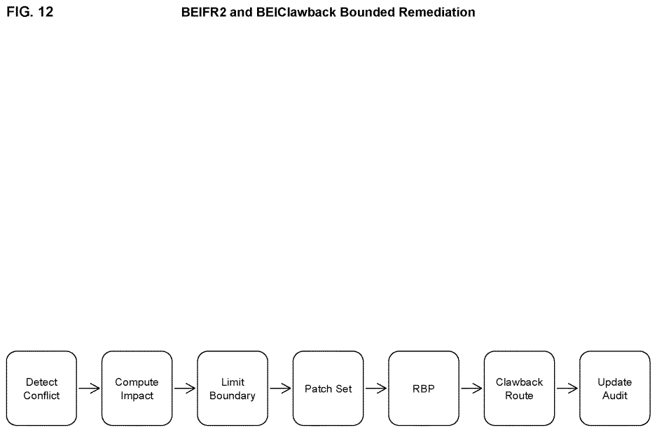

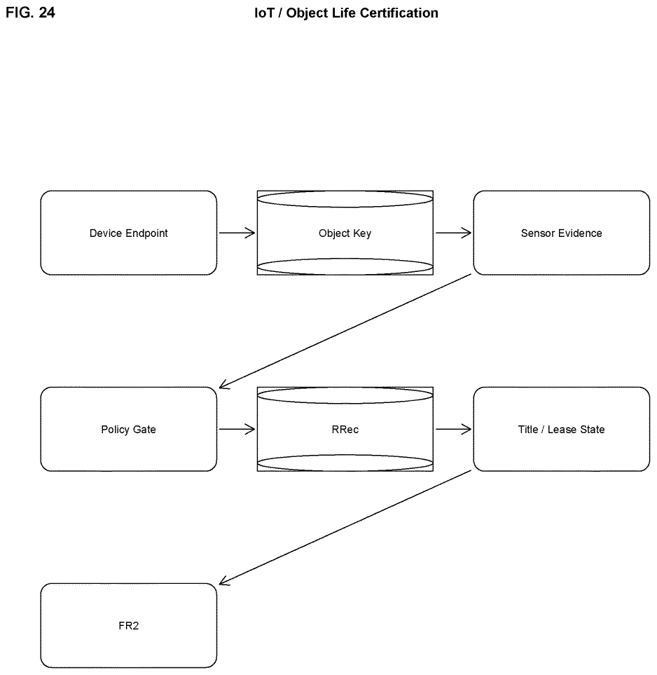

### CLAIM SUPPORT MATRIX

| Claim area | Specification support | Drawing support |
|---|---|---|
| Domain Name | Definitions; Redefined | FIGS. 1, 2, |
| redefinition | Domain Name; DBN; | 25 |
| | Domain Parcelization; | |
| | Sovereign Parcel | |
| Internet | Redefined Internet; Policy | FIGS. 1, 3, 6, |
| redefinition | Container Kernel; | 15 |
| | RRec/ACR/Marker/RBP | |
| Internet Economy | Redefined Internet | FIGS. 1, 4, 8, |
| redefinition | Economy; Object- | 9, 10, 12 |
| | confirmed BEI graph; | |
| | ATMS/BEIMINT/BEIGX/ | |
| | BEIIndex/BEIMarket | |
| BEI-TVP/Fission | Data Structures; Domain- | FIGS. 5, 7, |
| Root | Origin Processing Flow; | 13, 25 |
| | Non-duplication; | |
| | Derivative Graph | |
| BEIFR2/ | Non-Duplication, BEIFR2, | FIGS. 6, 11, |
| BEIClawback | and BEIClawback; | 15, 25 |
| | Remediation steps | |
| Asset Package | Asset Package, Licensing, | FIGS. 12, 24, |
| | and Valuation Support | 25 |

### Additional Implementation Details

### Canonicalization

Canonicalization may use deterministic field ordering, Unicode normalization, punycode normalization for domain labels, stable set ordering, explicit null omission, fixed timestamp encodings, bounded payload digests, replay-prevention values, and schema version identifiers. In implementation 1, the fields may be included directly in the relevant record or indirectly by digest, pointer, Merkle proof, receipt reference, or policy-container output while preserving external recomputability and independent verification.

Canonicalization may use deterministic field ordering, Unicode normalization, punycode normalization for domain labels, stable set ordering, explicit null omission, fixed timestamp encodings, bounded payload digests, replay-prevention values, and schema version identifiers. In implementation 2, the fields may be included directly in the relevant record or indirectly by digest, pointer, Merkle proof, receipt reference, or policy-container output while preserving external recomputability and independent verification.

Canonicalization may use deterministic field ordering, Unicode normalization, punycode normalization for domain labels, stable set ordering, explicit null omission, fixed timestamp encodings, bounded payload digests, replay-prevention values, and schema version identifiers. In implementation 3, the fields may be included directly in the relevant record or indirectly by digest, pointer, Merkle proof, receipt reference, or policy-container output while preserving external recomputability and independent verification.

### Policy Container

A policy container may include identity predicates, risk predicates, privacy predicates, compliance predicates, object-confirmation predicates, Time-of-Time predicates, minting predicates, clearing predicates, index predicates, licensing predicates, and remediation predicates. In implementation 1, the fields may be included directly in the relevant record or indirectly by digest, pointer, Merkle proof, receipt reference, or policy-container output while preserving external recomputability and independent verification.

A policy container may include identity predicates, risk predicates, privacy predicates, compliance predicates, object-confirmation predicates, Time-of-Time predicates, minting predicates, clearing predicates, index predicates, licensing predicates, and remediation predicates. In implementation 2, the fields may be included directly in the relevant record or indirectly by digest, pointer, Merkle proof, receipt reference, or policy-container output while preserving external recomputability and independent verification.

A policy container may include identity predicates, risk predicates, privacy predicates, compliance predicates, object-confirmation predicates, Time-of-Time predicates, minting predicates, clearing predicates, index predicates, licensing predicates, and remediation predicates. In implementation 3, the fields may be included directly in the relevant record or indirectly by digest, pointer, Merkle proof, receipt reference, or policy-container output while preserving external recomputability and independent verification.

### Scope Token

A scope token may bind scope_token_id, scope_id, subject_id, policy_digest, effective_time_window, disclosure_whitelist_digest, action_allowlist_digest, replay value, issuance timestamp, capability vector, and signature bundle. In implementation 1, the fields may be included directly in the relevant record or indirectly by digest, pointer, Merkle proof, receipt reference, or policy-container output while preserving external recomputability and independent verification.

A scope token may bind scope_token_id, scope_id, subject_id, policy_digest, effective_time_window, disclosure_whitelist_digest, action_allowlist_digest, replay value, issuance timestamp, capability vector, and signature bundle. In implementation 2, the fields may be included directly in the relevant record or indirectly by digest, pointer, Merkle proof, receipt reference, or policy-container output while preserving external recomputability and independent verification.

A scope token may bind scope_token_id, scope_id, subject_id, policy_digest, effective_time_window, disclosure_whitelist_digest, action_allowlist_digest, replay value, issuance timestamp, capability vector, and signature bundle. In implementation 3, the fields may be included directly in the relevant record or indirectly by digest, pointer, Merkle proof, receipt reference, or policy-container output while preserving external recomputability and independent verification.

### Reason Codes

Reason codes may include RC_SCOPE_EXPIRED, RC_POLICY_VERSION_MISMATCH, RC_DISCLOSURE_VIOLATION, RC_DUAL_ANCHOR_DRIFT, RC_ATTESTATION_INVALID, RC_DUPLICATE_VALUE, RC_DOWNGRADE_DETECTED, RC_FINALITY_MISMATCH, RC_OBJECT_UNCONFIRMED, and RC_AUTHORITY_QUORUM_FAILED. In implementation 1, the fields may be included directly in the relevant record or indirectly by digest, pointer, Merkle proof, receipt reference, or policy-container output while preserving external recomputability and independent verification.

Reason codes may include RC_SCOPE_EXPIRED, RC_POLICY_VERSION_MISMATCH, RC_DISCLOSURE_VIOLATION, RC_DUAL_ANCHOR_DRIFT, RC_ATTESTATION_INVALID, RC_DUPLICATE_VALUE, RC_DOWNGRADE_DETECTED, RC_FINALITY_MISMATCH, RC_OBJECT_UNCONFIRMED, and RC_AUTHORITY_QUORUM FAILED. In implementation 2, the fields may be included directly in the relevant record or indirectly by digest, pointer, Merkle proof, receipt reference, or policy-container output while preserving external recomputability and independent verification.

Reason codes may include RC_SCOPE_EXPIRED, RC_POLICY_VERSION_MISMATCH, RC_DISCLOSURE_VIOLATION, RC_DUAL_ANCHOR_DRIFT, RC_ATTESTATION_INVALID, RC_DUPLICATE_VALUE, RC_DOWNGRADE_DETECTED, RC_FINALITY_MISMATCH, RC_OBJECT_UNCONFIRMED, and RC_AUTHORITY_QUORUM FAILED. In implementation 3, the fields may be included directly in the relevant record or indirectly by digest, pointer, Merkle proof, receipt reference, or policy-container output while preserving external recomputability and independent verification.

### Proofs

Proofs may include DNSSEC proof, registry proof, DID document proof, verifiable credential proof, zero-knowledge proof, multi-party computation output, Merkle inclusion proof, rail finality proof, threshold signature proof, device attestation, and knowledge graph digest. In implementation 1, the fields may be included directly in the relevant record or indirectly by digest, pointer, Merkle proof, receipt reference, or policy-container output while preserving external recomputability and independent verification.

Proofs may include DNSSEC proof, registry proof, DID document proof, verifiable credential proof, zero-knowledge proof, multi-party computation output, Merkle inclusion proof, rail finality proof, threshold signature proof, device attestation, and knowledge graph digest. In implementation 2, the fields may be included directly in the relevant record or indirectly by digest, pointer, Merkle proof, receipt reference, or policy-container output while preserving external recomputability and independent verification.

Proofs may include DNSSEC proof, registry proof, DID document proof, verifiable credential proof, zero-knowledge proof, multi-party computation output, Merkle inclusion proof, rail finality proof, threshold signature proof, device attestation, and knowledge graph digest. In implementation 3, the fields may be included directly in the relevant record or indirectly by digest, pointer, Merkle proof, receipt reference, or policy-container output while preserving external recomputability and independent verification.

### Currency and Time

TimeCurrency may use TimeSecond, TimeMinute, TimeHour, TimeDay, TimeWeek, TimeMonth, Time Year, TimeGR, BEI-GR, and Time-of-Time coordinates under deterministic taxonomy and policy-defined conversion or decay parameters. In implementation 1, the fields may be included directly in the relevant record or indirectly by digest, pointer, Merkle proof, receipt reference, or policy-container output while preserving external recomputability and independent verification.

TimeCurrency may use TimeSecond, TimeMinute, TimeHour, TimeDay, TimeWeek, TimeMonth, Time Year, TimeGR, BEI-GR, and Time-of-Time coordinates under deterministic taxonomy and policy-defined conversion or decay parameters. In implementation 2, the fields may be included directly in the relevant record or indirectly by digest, pointer, Merkle proof, receipt reference, or policy-container output while preserving external recomputability and independent verification.

TimeCurrency may use TimeSecond, TimeMinute, TimeHour, TimeDay, TimeWeek, TimeMonth, Time Year, TimeGR, BEI-GR, and Time-of-Time coordinates under deterministic taxonomy and policy-defined conversion or decay parameters. In implementation 3, the fields may be included directly in the relevant record or indirectly by digest, pointer, Merkle proof, receipt reference, or policy-container output while preserving external recomputability and independent verification.

### Object Confirmation

Object confirmation may use GOK, object key, transaction object, service object, medical evidence object, IoT sensor object, identity document object, title object, communication entrance object, or asset-package object. In implementation 1, the fields may be included directly in the relevant record or indirectly by digest, pointer, Merkle proof, receipt reference, or policy-container output while preserving external recomputability and independent verification.

Object confirmation may use GOK, object key, transaction object, service object, medical evidence object, IoT sensor object, identity document object, title object, communication entrance object, or asset-package object. In implementation 2, the fields may be included directly in the relevant record or indirectly by digest, pointer, Merkle proof, receipt reference, or policy-container output while preserving external recomputability and independent verification.

Object confirmation may use GOK, object key, transaction object, service object, medical evidence object, IoT sensor object, identity document object, title object, communication entrance object, or asset-package object. In implementation 3, the fields may be included directly in the relevant record or indirectly by digest, pointer, Merkle proof, receipt reference, or policy-container output while preserving external recomputability and independent verification.

### Security

Security may use non-bypassable commit gates, audit-commit gates, dual anchoring, key rotation receipts, qualified-signature and key-qualification options, selective disclosure, ZK proofs, MPC aggregation, homomorphic proof outputs, and append-only audit chains. In implementation 1, the fields may be included directly in the relevant record or indirectly by digest, pointer, Merkle proof, receipt reference, or policy-container output while preserving external recomputability and independent verification.

Security may use non-bypassable commit gates, audit-commit gates, dual anchoring, key rotation receipts, qualified-signature and key-qualification options, selective disclosure, ZK proofs, MPC aggregation, homomorphic proof outputs, and append-only audit chains. In implementation 2, the fields may be included directly in the relevant record or indirectly by digest, pointer, Merkle proof, receipt reference, or policy-container output while preserving external recomputability and independent verification.

Security may use non-bypassable commit gates, audit-commit gates, dual anchoring, key rotation receipts, qualified-signature and key-qualification options, selective disclosure, ZK proofs, MPC aggregation, homomorphic proof outputs, and append-only audit chains. In implementation 3, the fields may be included directly in the relevant record or indirectly by digest, pointer, Merkle proof, receipt reference, or policy-container output while preserving external recomputability and independent verification.

### Standards

Adapters may map canonical intent envelopes to ISO 20022, VC-style credential carriers, DNSSEC, secure transport records, traditional rails, token ledgers, CBDC ledgers, ACH/RTGS/RTP rails, SWIFT-compatible messages, medical protocols, IoT telemetry, or enterprise event systems. In implementation 1, the fields may be included directly in the relevant record or indirectly by digest, pointer, Merkle proof, receipt reference, or policy-container output while preserving external recomputability and independent verification.

Adapters may map canonical intent envelopes to ISO 20022, VC-style credential carriers, DNSSEC, secure transport records, traditional rails, token ledgers, CBDC ledgers, ACH/RTGS/RTP rails, SWIFT-compatible messages, medical protocols, IoT telemetry, or enterprise event systems. In implementation 2, the fields may be included directly in the relevant record or indirectly by digest, pointer, Merkle proof, receipt reference, or policy-container output while preserving external recomputability and independent verification.

Adapters may map canonical intent envelopes to ISO 20022, VC-style credential carriers, DNSSEC, secure transport records, traditional rails, token ledgers, CBDC ledgers, ACH/RTGS/RTP rails, SWIFT-compatible messages, medical protocols, IoT telemetry, or enterprise event systems. In implementation 3, the fields may be included directly in the relevant record or indirectly by digest, pointer, Merkle proof, receipt reference, or policy-container output while preserving external recomputability and independent verification.

### Asset Diligence

A data-room matrix may include patent family entries, claim element IDs, figures, module IDs, domain asset refs, trademark refs, API specs, RRec/ACR/RBP samples, index samples, licensing fields, royalty calculations, and remediation history. In implementation 1, the fields may be included directly in the relevant record or indirectly by digest, pointer, Merkle proof, receipt reference, or policy-container output while preserving external recomputability and independent verification.

A data-room matrix may include patent family entries, claim element IDs, figures, module IDs, domain asset refs, trademark refs, API specs, RRec/ACR/RBP samples, index samples, licensing fields, royalty calculations, and remediation history. In implementation 2, the fields may be included directly in the relevant record or indirectly by digest, pointer, Merkle proof, receipt reference, or policy-container output while preserving external recomputability and independent verification.

A data-room matrix may include patent family entries, claim element IDs, figures, module IDs, domain asset refs, trademark refs, API specs, RRec/ACR/RBP samples, index samples, licensing fields, royalty calculations, and remediation history. In implementation 3, the fields may be included directly in the relevant record or indirectly by digest, pointer, Merkle proof, receipt reference, or policy-container output while preserving external recomputability and independent verification.

### Detailed Domain Name Redefinition Embodiments

A conventional domain name typically resolves to a network service. In contrast, a BEI domain-origin basepoint may resolve to a bundle of technical authorities including a namespace authority, a policy authority, an evidence authority, a key authority, a value-routing authority, and a remediation authority.

A DBN may expose a policy endpoint, a receipt endpoint, a scope-token endpoint, a catalog endpoint, a verifier endpoint, a dispute endpoint, a callback endpoint, and an adapter endpoint. These endpoints may be implemented at one domain, multiple subdomains, a registry object, a DID document, or a secure service-binding record.

A domain-origin basepoint may be associated with a curated root in a domain treasury catalog. The catalog may store root_digest, catalog_digest, taxonomy_tag_set, policy_pack_id, jurisdiction_tag_set, anchor_mode, standards_profile_id, and migration_digest. A verifier may recompute namespace_id from catalog_version, root_digest, policy_pack_id, and canonicalization rules.

A BEI domain name may spawn sovereign parcels. A sovereign parcel may be a child namespace that inherits a policy boundary from a parent basepoint while adding a subject identity, entitlement vector, effective time window, recognition level, and transfer or minting capability.

A sovereign parcel may transition from an inactive or Virgin-Land state into an activated Treasure-Bowl state. The transition may be receipt-gated and may emit an activation receipt, a FINAL marker, and a parcel receipt binding parent_scope_id, child_scope_id, subject_id, policy_digest, and signature bundle.

The term Treasure Bowl may refer to an activated scope capable of producing authorized BEI value records. The term Virgin Land may refer to a pre-activation scope, basepoint, or domain parcel capable of future activation under a policy container. These metaphorical names do not limit the technical fields recited in the claims.

In one embodiment, a country or region root, industry root, medical root, time root, culture root, trust root, A-to-Z root, or resource root may act as a DBN. A person, family, enterprise, institution, city, state, country, device, service endpoint, or industry group may receive a child scope under the root.

The domain name thereby becomes a reusable control primitive. It is not merely a locator; it is a scope-defining device that permits evidence, policy, identity, time, currency, clearing, index, licensing, and remediation modules to interoperate without relying on a private platform database.

A domain-origin basepoint may be dual anchored. A first anchor may be a DNSSEC or registry proof. A second anchor may be a DID document, distributed ledger record, transparency log entry, or signed manifest. If drift occurs between anchors, the system may emit a CONFLICT marker and freeze affected actions pending remediation.

A DBN may optionally support secure discovery through DNS-over-HTTPS, DNS-over-TLS, HTTPS/SVCB records, registry attestations, or signed service manifests. The discovery path may be hashed into a discovery_digest and bound to an RRec for later audit.

When a domain basepoint is transferred, renewed, delegated, retired, or migrated, the system may issue a catalog transition receipt. The receipt preserves continuity between prior namespace_id and migrated namespace_id, preventing unauthorized substitution of a policy authority.

A domain-origin basepoint may contain time-domain subscopes such as hour, day, week, month, year, TimeGR, BEI-GR, or Time-of-Time coordinates. A time-domain subscope may determine eligibility windows, quota windows, decay rules, minting windows, or remediation windows.

A domain-origin basepoint may contain industry subscopes such as health, finance, retail, logistics, insurance, education, energy, mobility, IoT, media, agriculture, governance, and public safety. Each industry subscope may load an IndustryPack while preserving the same RRec, ACR, Marker, and RBP primitives.

A domain-origin basepoint may contain need subscopes corresponding to human needs. Each NeedPack may map a need-class identifier to policy predicates, evidence gates, entitlement vectors, value-unit parameters, license fields, and remediation limits.

The domain basepoint may be used by a co-owner rather than a platform user. The co-owner model is implemented by binding subject identity, entitlement vector, and ownership or stewardship scope into the RRec and parcel receipt, not by merely adding a label to a platform account.

A verifier may determine whether a domain-origin action was valid by resolving the DBN, validating policy digest, recomputing intent digest, checking receipt signature, checking finality proof, and verifying that the action remained within scope-token and time-boundary limits.

The foregoing mechanisms support a technical redefinition of domain name as a programmable, auditable, identity-binding, value-routing node.

Because a DBN may define the root of a BEI branch node, every later currency, time, index, exchange, license, royalty, or remediation output can be traced back to a domain-origin basepoint and not merely to an internal platform account.

A domain-origin basepoint may further act as a standards gateway. A standards_profile_id can be associated with ISO 20022, VC-style credential, DNSSEC, jurisdictional compliance, medical, IoT, or enterprise event schemas, and the selected profile digest can be bound into RRec and ACR artifacts.

If a downstream adapter attempts to use a lower proof requirement than the applicable standards profile, the control plane sets downgrade_detected and emits a CONFLICT marker rather than silently accepting weaker settlement.

### Detailed Bei Internet Control Plane Embodiments

The BEI Internet control plane may include a resolver plane, identity plane, time plane, evidence plane, policy plane, receipt plane, clearing plane, index plane, market plane, and remediation plane. Each plane may be distributed across multiple systems while sharing canonical artifact formats.

The resolver plane converts a human-readable or machine-readable domain-origin identifier into namespace_id, key references, policy endpoints, profile digests, catalog digests, and adapter routes.

The identity plane resolves BEI co-owner identity, family identity, institutional identity, device identity, object identity, and jurisdictional identity. Identity resolution may include BEIDID, DID, EID, alias mapping, immutable identifier mapping, recognition tier, delegated keys, and recovery state.

The time plane binds Time-of-Time, timestamp, TimeGR, BEI-GR, time-domain coordinate, service interval, behavior interval, attester signature, and time-evidence digest. The time plane may determine value quantity and remediation eligibility.

The evidence plane receives object confirmation, service proof, device attestation, credential proof, transaction proof, medical evidence, IoT measurement, title proof, payment proof, or license proof. It may store raw evidence separately while binding evidence digest into RRec.

The policy plane executes deterministic policy containers. A policy container can be compiled from NeedPack, IndustryPack, JurisdictionPack, StandardsProfile, CurrencyPack, TimePack, PrivacyPack, and RemediationPack inputs.

The receipt plane emits RRec, THR, Marker, ACR, RBP, NonDuplicationReceipt, IndexPublicationReceipt, LicenseUseReceipt, and AssetPackageRecord. Artifacts may be stored in an append-only log, transparency log, distributed ledger, database, or hybrid evidence repository.

The clearing plane coordinates PREPARE, COMMIT, FINALITY_PROOF, ABORT, FREEZE, and REMEDIATE operations across heterogeneous rails. Rails may include bank cores, card networks, ACH, RTGS, RTP, token ledgers, enterprise ledgers, medical claims systems, IoT data systems, and marketplace ledgers.

The remediation plane prevents uncontrolled cascade. It computes pre-execution impact reports, dependency closures, blast-radius limits, time-domain boundaries, authority quorums, patch sets, and rollback proofs before correction.

The BEI Internet control plane thereby extends beyond application hosting. It provides a general protocol for governing behavioral-economic events across domain-origin namespaces.

### Differentiated Control-Plane Deployment Embodiments

Enterprise-hybrid control-plane embodiment: a domain-origin basepoint receives a signed intent envelope from a bank rail, medical endpoint, registry, marketplace node, or enterprise workflow system. The DBN resolver outputs namespace_id, scope_hash, policy_container_id, selected_standards_profile_digest, and verifier_endpoint. The policy container executes in a deterministic runtime, emits a decision_digest and allowed_action_set, and writes RRec, ACR, Marker, NonDuplicationReceipt, and RBP references to a permissioned ledger, append-only database, or transparency log.

Cloud-edge control-plane embodiment: a plurality of edge workers or containerized services implement DBN resolution, scope-token validation, policy selection, and RRec issuance. Each edge worker loads the same canonicalization rules and policy digest. When an edge node receives stale policy, expired scope, or mismatched profile input, it emits reason codes including RC_POLICY_VERSION_MISMATCH, RC_SCOPE_EXPIRED, or RC_DOWNGRADE_DETECTED and routes the event to HOLD or CONFLICT rather than FINAL.

Trusted-execution control-plane embodiment: the deterministic policy container runs inside a trusted execution environment, secure enclave, hardware security module, or hardware-attested service. The enclave receives canonical event bytes, identity anchor, time coordinate, object-state digest, and evidence digest; signs a policy decision; and returns an attestation digest that is bound into the RRec, ACR, and verifier reconstruction package.

Financial-rail control-plane embodiment: an ATMS node converts a canonical intent envelope into a clearing message compatible with a bank core, ACH, RTGS, RTP, SWIFT-compatible, card, token-ledger, CBDC, or ISO 20022-style rail. Standards-profile negotiation compares the required proof set against the offered adapter proof set. If downgrade_detected is true, the node sets LOCKED or CONFLICT, blocks FINAL, and emits RC_DOWNGRADE_DETECTED until a compliant mapping_digest, policy_digest, or proof_requirement is satisfied.

Medical, IoT, and AI-agent entrance embodiment: a medical device, IoT endpoint, telecom terminal, QR entrance, AI operator, or AI agent supplies object reference, device attestation, consent record, switch code, scene key, silent-echo signature, or sensor evidence digest. The Non-Duplication Controller compares candidate_hash, identity anchor, domain-origin ID, time window, object reference, behavior type, evidence digest, prior derivative references, and correction state before allowing minting, clearing, indexing, licensing, or remediation.

### Detailed Internet Economy Value Routing Embodiments

A BEI Internet Economy event starts from a co-owner-origin action. The action may be active, passive, service-based, medical, financial, educational, creative, caregiving, industrial, civic, IoT-assisted, communication-based, or domain-parcel-based.

The system does not reward the existence of raw activity alone. The system admits value only after domain-origin verification, identity binding, time proof, object confirmation, evidence digesting, policy execution, non-duplication checking, and receipt generation.

A BEI-TVP or fission-root record may become the root of a derivative graph. The derivative graph may include time currency, BEI currency, index, clearing, license, royalty, grant, health grain, insurance, title, collateral, market listing, data-room, or remediation derivatives.

ATMS may serve as an asset-time-money-service/system router. It may receive a validated root record and determine whether the record should be routed to minting, savings, collateral, credit, settlement, title, insurance, index, or market modules.

BEIMINT may serve as the minting authorization node. It may check proof completeness, role attestations, green governance indicators, non-duplication state, currency policy, reserve parameters, and finality prerequisites before generating an issuance record.

MF.app may serve as a Mint Factory, Money Factory, or Monetary Factory endpoint. It may provide implementation access to minting factories while remaining governed by the same domain-origin policy and receipt system.

BEICurrency.com may serve as a lifecycle node for BEI Currency. It may manage issuance, allocation, transfer, freeze, burn, reserve, re-indexing, license link, and correction states.

TimeCurrency endpoints may serve as lifecycle nodes for time-denominated value. They may manage verified intervals, time attestations, TimeGR, BEI-GR, time reserve units, time bank entries, time ledger entries, and time vault states.

BEIGX may serve as a global exchange, grant exchange, growth exchange, goods exchange, or general exchange node for listing, transfer, licensing, and settlement of BEI value records.

BEIIndex may serve as an index publication node. It may compute personal, family, industry, regional, national, jurisdictional, medical, time-behavior, reserve, and asset-package indices from proof-carrying artifacts.

BEIMarket may serve as the licensing and transfer marketplace. It may package claim elements, domain assets, trademarks, APIs, modules, NeedPacks, IndustryPacks, receipt examples, data-room records, license fields, and royalty-basis records into transfer-ready asset packages.

### Differentiated Value-Routing Embodiments

Root-to-currency embodiment: a single fission-root record may generate a TimeCurrency unit, BEI Currency unit, reserve record, allocation record, or lifecycle record only after policy approval, non-duplication allowance, and proof-artifact generation. Each derivative stores root_id, correction_dependency, non_duplication_reference, and audit anchor.

Root-to-clearing embodiment: a root event may generate an ACR that binds clearing_intent_digest, rail_set, prepare_proof_set, commit_proof_set, finality_proof_set, resulting_state_digest, and external_reference_set. A mismatch between the ACR and external verifier reconstruction causes HOLD or CONFLICT rather than FINAL.

Root-to-index embodiment: aggregated RRec, ACR, BEI-TVP, fission-root, Q-qualified evidence, and correction-state records may be routed to a BEIIndex node. The index output is bound to an index publication_receipt and may be revised when a correction dependency changes.

Root-to-license embodiment: a root event or derivative record may generate a license-use record, royalty-basis record, grant record, field-of-use restriction, or transfer record. The license derivative remains linked to the root through correction_dependency and NonDuplicationReceipt to prevent duplicate royalty recognition or asset-package inclusion.

Root-to-asset-package embodiment: a BEIMarket or data-room node may bind claim_element_id, module_id, domain_asset_ref, trademark_ref, API_ref, SKU_ref, license_field, royalty_basis, and evidence_pointer. The resulting asset-package record supports due diligence without relying on unverified spreadsheets or promotional valuation statements.

### Object Confirmation and Dependency Graph Embodiments

Object-confirmation embodiment 1: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 2: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 3: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 4: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 5: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 6: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 7: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 8: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 9: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 10: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 11: the system may confirm an object by one or more of a physical object key, digital object key, service evidence hash, device attestation, medical-event object, payment object, domain parcel, title record, communication entrance event, object is represented by an object_reference and bound into the BEI-TVP or fission-root record.

Object-confirmation embodiment 12: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 13: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 14: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 15: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 16: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 17: the system may confirm an object by one or more of a physical object key, digital object key, service evidence hash, device attestation, medical-event object, payment object, domain parcel, title record, communication entrance event, object is represented by an object_reference and bound into the BEI-TVP or fission-root record.

Object-confirmation embodiment 18: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 19: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 20: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 21: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 22: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 23: the system may confirm an object by one or more of a physical object key, digital object key, service evidence hash, device attestation, medical-event object, payment object, domain parcel, title record, communication entrance event, object is represented by an object_reference and bound into the BEI-TVP or fission-root record.

Object-confirmation embodiment 24: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 25: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 26: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 27: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 28: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

Object-confirmation embodiment 29: the system may confirm an object by one or more of a physical object key, digital object key, service evidence hash, device attestation, medical-event object, payment object, domain parcel, title record, communication entrance event, object is represented by an object_reference and bound into the BEI-TVP or fission-root record.

Object-confirmation embodiment 30: the system may confirm an object by one or more of a physical object key, digital object key, service evidence hash, device attestation, medical-event object, payment object, domain parcel, title record, communication entrance event, location-time proof, counterparty signature, or knowledge-graph feature digest. The confirmed object is represented by an object_reference and bound into the BEI-TVP or fission-root record.

### Anti-Rejection Claim Chart Embodiments

101 technical improvement: Deterministic policy sandbox; canonicalized inputs; proof-carrying artifacts; atomic clearing; bounded remediation; external recomputation.

112 written description: Definitions; field maps; examples; state machines; artifact schemas; figures; claim support matrix.

112 enablement: Step-by-step processing flow; record fields; failure states; remediation steps; adapter interfaces; verification rules.

102 distinction: No single prior system teaches domain-origin BEI co-owner identity+Time-of-Time+object-confirmed fission root+non-duplication+RRec/ACR finality+BEIFR2+asset-package routing.

103 distinction: The combination is not a predictable aggregation; the output is a new necessary control passage with non-duplicative value creation, proof-backed clearing, and bounded correction.

Licensing leverage: Claim-to-SKU-to-domain-to-market mapping connects claim elements to modules and vertical licensing fields.

Asset package leverage: Data-room evidence matrix links patents, domains, trademarks, APIs, receipts, indices, currency records, and remediation history.

### Prosecution Support and Prior-Art Distinction Embodiments

In a prosecution support embodiment, conventional DNS may be distinguished because the claimed domain-origin basepoint does not merely resolve a name to an address. It binds namespace scope, identity endpoint, policy authority, evidence admission, receipt generation, value routing, finality control, non-duplication control, and bounded remediation scope into a machine-verifiable infrastructure node.

Conventional DID or credential systems may be distinguished because identity proof alone does not generate a domain-origin root event, deterministic policy decision, NonDuplicationReceipt, ACR finality, BEIFR2 rollback proof, or claim-to-SKU asset-package record.

Conventional blockchain, token, or smart-contract systems may be distinguished because immutable or probabilistic finality alone does not compute a bounded blast radius, time-domain boundary, impact-scope boundary, patch-set digest, supervisory authorization receipt, and rollback proof while preserving unaffected finality.

Conventional payment or clearing systems may be distinguished because they do not begin with a domain-origin behavior-time-object evidence root and do not write clearing finality back into identity, index, license, royalty, grant, and remediation dependency states.

The non-obvious coupling is that the output of each upstream module becomes a required verification input, state gate, or remediation boundary for downstream modules, and downstream receipts write back to the dependency graph. This coupling reduces duplicate value recognition, finality mismatch, downgrade acceptance, and unbounded correction cascade in a manner not supplied by any individual prior-art component.

### Asset Package and Cross-Layer Protection Embodiments

Asset-package embodiment: a data-room matrix maps claim elements to domain assets, trademarks, software modules, APIs, receipts, audit artifacts, index outputs, currency lifecycle records, licensing fields, royalty-basis records, NeedPack identifiers, IndustryPack identifiers, JurisdictionPack identifiers, and remediation histories. Each row may be generated from proof-carrying artifacts rather than manually entered valuation assertions.

Claim-to-SKU embodiment: a claim-to-SKU engine receives claim_element_id, module_id, implementation_endpoint, standards_profile_id, domain_asset_ref, trademark_ref, API_ref, license_field, royalty_basis, and evidence_pointer. The engine outputs a diligence record suitable for field-of-use licensing, transfer review, portfolio segmentation, infringement mapping, and revenue attribution.

Royalty-basis embodiment: a market or data-room node may compute a royalty basis from receipt counts, ACR counts, mint authorization events, index publication events, license-use records, asset-package listings, or verified API calls. The computed royalty basis is bound to a receipt or audit pointer so that a licensee or verifier can reconstruct the calculation.

Cross-layer protection embodiment: a domain-origin functional node may be linked to a patent family record, trademark record, domain asset, software module, standards interface, proof artifact, and remediation history. This mapping supports technical diligence and licensing without expanding the claim scope beyond the computer-implemented mechanisms disclosed herein.

### Additional Figure Implementation Notes

The figures are engineering claim maps. Each figure identifies modules, records, data flows, control flows, state transitions, or data-room outputs that may be implemented by hardware processors, memory, network interfaces, deterministic policy runtimes, resolver services, receipt stores, adapter services, clearing services, index services, market services, and remediation services.

The FIG. 1 to FIG. 3 trilogy defines the three primary invention axes: domain name as domain-origin basepoint, Internet as domain-origin control plane, and Internet Economy as co-owner behavioral-economic value network.

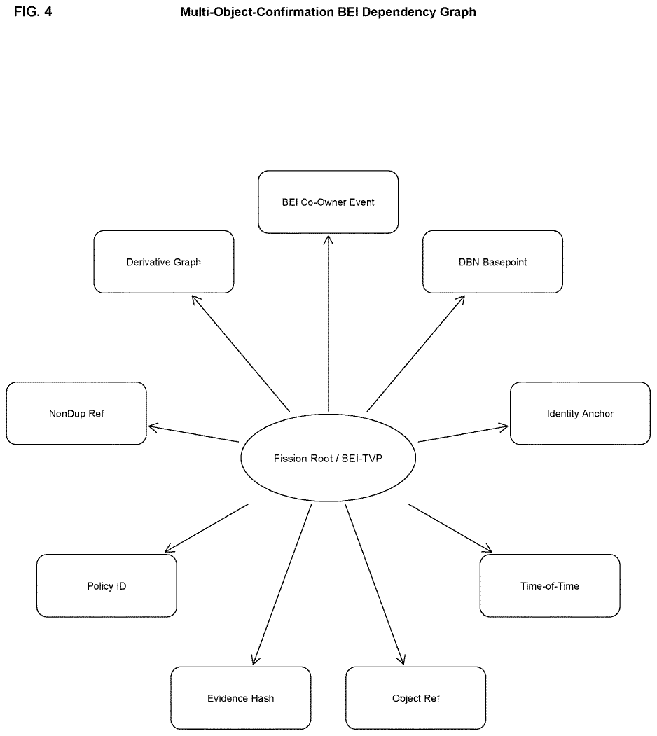

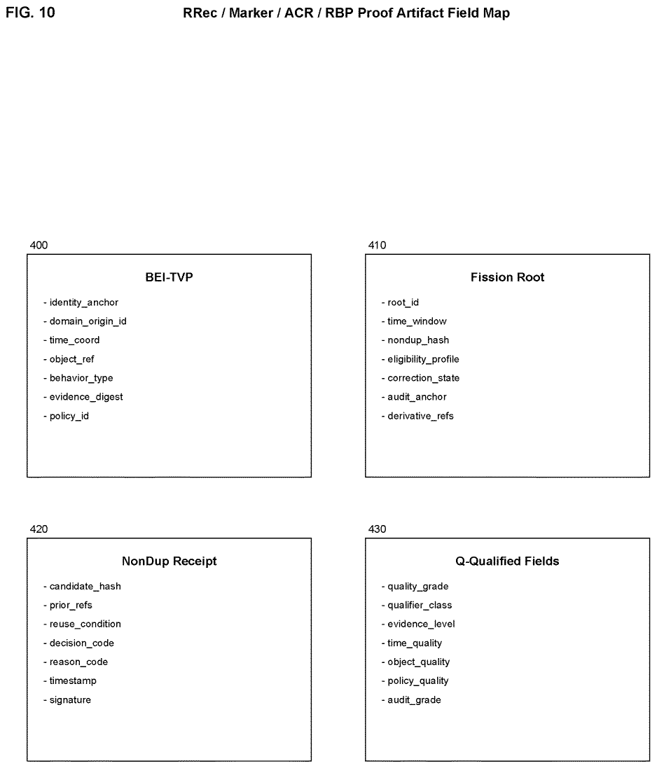

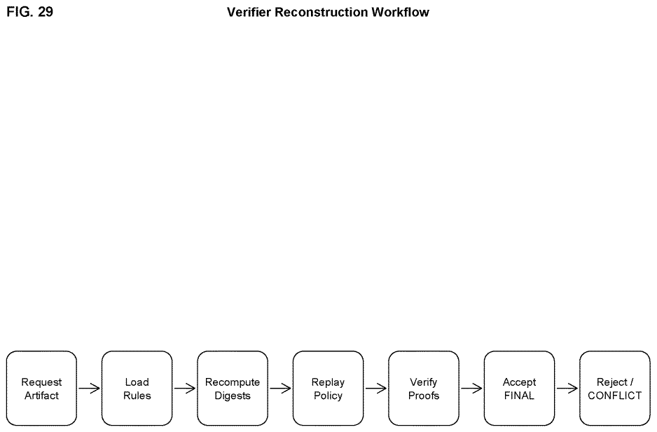

The FIG. 4, FIG. 7, FIG. 10, FIG. 11, FIG. 12, and FIG. 29 group supplies field-level and state-machine support for record generation, proof artifacts, verifier reconstruction, non-duplication, finality, and bounded remediation.

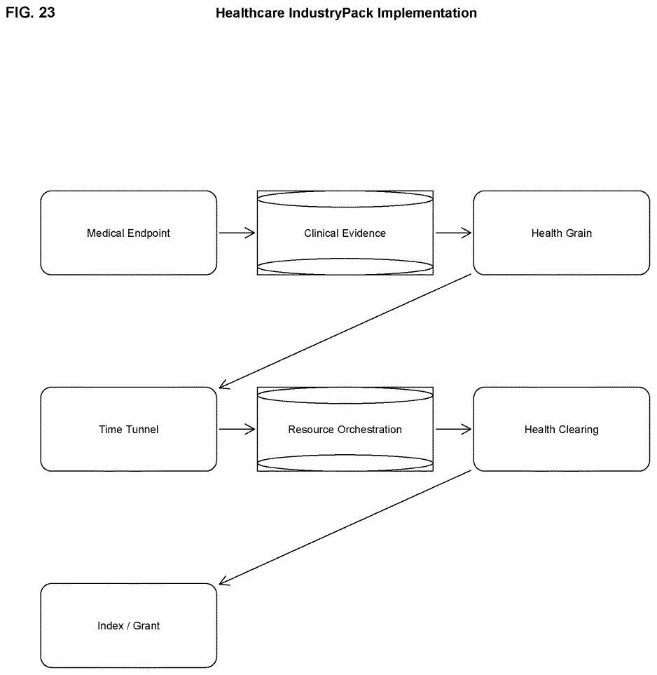

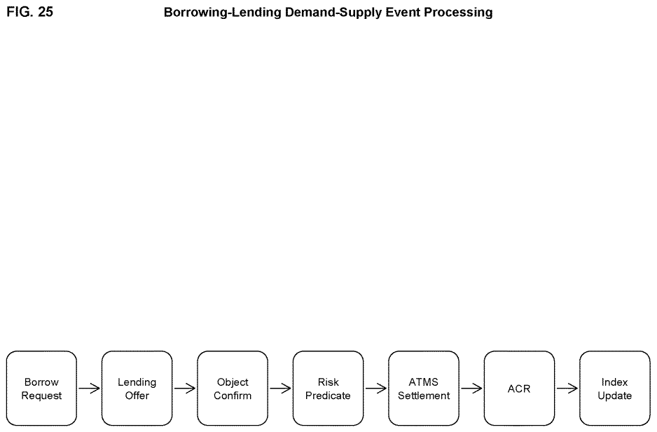

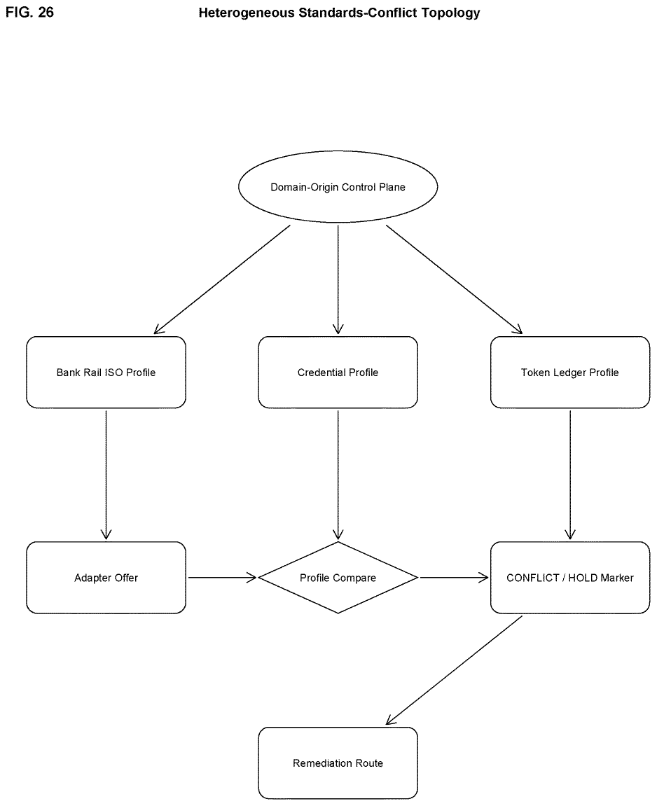

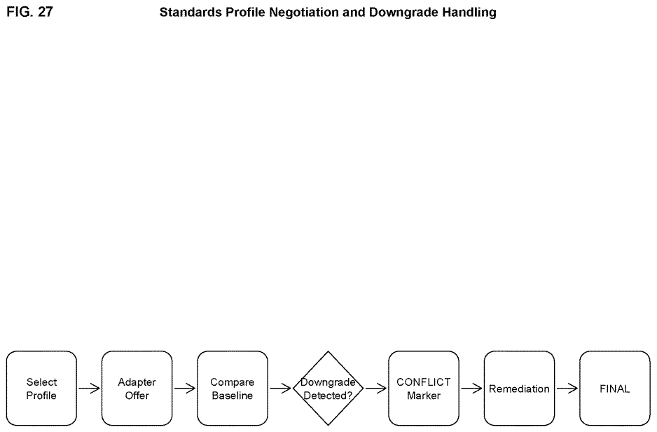

The FIG. 5, FIG. 23, FIG. 24, FIG. 25, FIG. 26, and FIG. 27 group supplies heterogeneous deployment support for NeedPack, IndustryPack, medical, IoT, lending, standards negotiation, and downgrade handling embodiments.

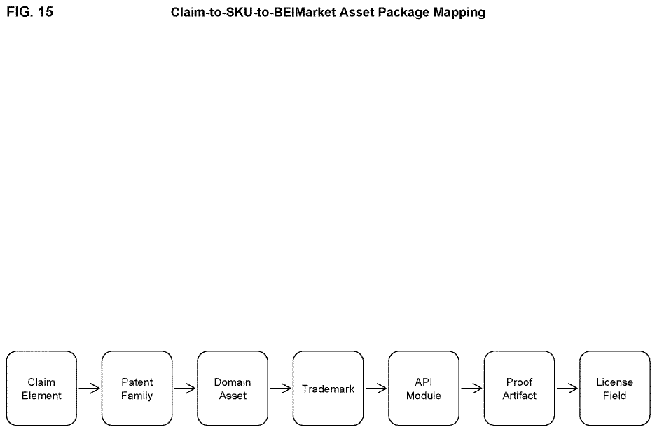

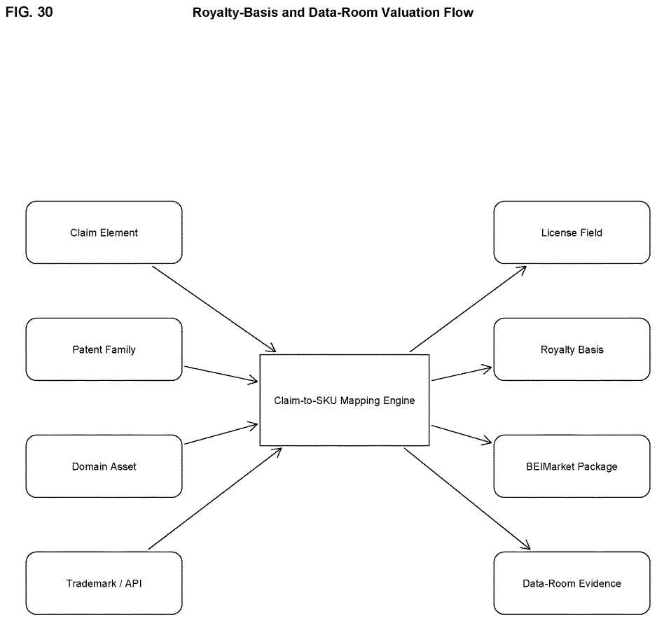

The FIG. 15 and FIG. 30 group supplies asset-package and valuation support by mapping claim elements to technical SKUs, domain assets, trademarks, API modules, proof artifacts, license fields, royalty bases, BEIMarket packages, and data-room evidence pointers.

### V6 Strengthening: Qualified Q-Layer, 98-Page-Oriented Disclosure, and No-Loss Continuity

The term “Q” in this disclosure is used as a qualified, qualifier-based, quality-of-proof, and quantity-normalized indicator, and not as a required specialized nonstandard-computing implementation. In any embodiment where earlier materials used a qualified-oriented label, the present disclosure may implement the same functional role as a qualified evidence signal, qualified time coordinate, qualified identity reference, qualified policy result, qualified value quantity, or qualified remediation boundary. This avoids requiring a specialized nonstandard device, specialized nonstandard network, or specialized nonstandard algorithm to practice the invention while preserving the useful Q concept as a machine-verifiable quality and qualification layer.

A Q-qualified record may include a qualifier class, evidence-quality score, source-quality level, object-confirmation grade, time-coordinate quality, policy-version quality, non-duplication confidence, remediation eligibility grade, and audit reproducibility grade. The Q-qualified record may be stored in or referenced by a BEI-TVP record, fission-root record, RRec, ACR, FinalityMarker, NonDuplicationReceipt, BEI Currency lifecycle record, TimeCurrency record, index record, license record, royalty-basis record, or asset-package diligence record.

The Q-qualified layer therefore lowers implementation difficulty. A practical embodiment may use ordinary cryptographic signatures, public-key infrastructure, DID-compatible references, DNSSEC or equivalent domain-anchor proofs, selective-disclosure credentials, verifiable credentials, hash commitments, secure logs, hardware-backed attestations, server-side verification, or database transaction controls. The invention does not depend on a difficult-to-implement specialized nonstandard infrastructure.

### Domain Name Redefinition—Engineering Embodiments

A BEI domain name is a domain-origin basepoint that includes or references a domain identifier, namespace scope, policy endpoint, BEI co-owner identity endpoint, evidence-admission rule, Time-of-Time reference, object-confirmation rule, non-duplication rule, value-routing rule, and bounded-remediation rule. Unlike a conventional domain label that merely resolves an address or website, the BEI domain name acts as a programmable infrastructure gate for admitting behavioral-economic identity events.

A DBN resolver may receive a domain name, determine a domain-origin scope, locate a signed anchor manifest, identify an applicable policy container, derive a scope hash, and expose a BEI-DEN or equivalent domain endpoint record. The output of the resolver is not merely an IP address; it is a machine-usable policy and evidence routing state that controls downstream BEI-TVP generation, minting, clearing, index publication, and remediation.

The domain-origin basepoint may be subdivided into sovereign parcels, sub-parcels, branch nodes, store nodes, franchise nodes, time cells, jurisdiction nodes, NeedPack cells, IndustryPack cells, medical-health cells, education cells, finance cells, IoT cells, and family or household cells. Each subdivision inherits policy constraints from the parent domain-origin basepoint while maintaining its own evidence, time, identity, and value-routing references.

A BEI domain parcel may be treated as a technical namespace object, not merely as real estate metaphor. The parcel has a parcel identifier, parent domain reference, child-scope rules, authorization profile, minting-right profile, clearing-right profile, license-slice profile, and BEIFR2 remediation profile. A parcel action may be rejected when the policy container, non-duplication controller, or reconciliation marker indicates a conflict, downgrade, expired time window, or unsupported evidence grade.

The domain-origin basepoint may support the Treasure Bowl and Virgin Land implementation by allowing many BEI co-owner identity endpoints to establish scoped terminal territories, but the patentable mechanism is the controlled domain-origin allocation process, not a slogan. A scoped terminal territory is created by resolving the domain basepoint, applying a policy container, binding a BEI co-owner identity, assigning a parcel or sub-parcel, and issuing a receipt-backed entitlement record.

### Internet Redefinition—Control Plane Embodiments

The BEI Internet is a domain-origin control plane that processes identity, time, behavior, evidence, policy, receipt, clearing, index, authorization, and remediation records. A conventional Internet packet network may be used as a transport layer, but the inventive control plane adds a policy-executing and proof-generating layer above mere packet delivery.

A BEI Internet message may include a canonicalized intent envelope, domain-origin identifier, BEI co-owner identity reference, object reference, behavior-event type, time-coordinate reference, evidence digest, policy-container identifier, replay-prevention value, scope token, selected standards profile, and requested output class. The policy container executes over these fields to determine whether to approve, limit, hold, revoke, remediate, mint, clear, index, license, or reject the event.

The Internet control plane may include a DBN resolver, BEI identity resolver, time-coordinate resolver, object-confirmation gate, evidence-admission gate, deterministic policy kernel, non-duplication controller, proof artifact service, ATMS settlement adapter, BEIMINT adapter, BEIGX exchange adapter, BEIIndex publication adapter, BEIMarket licensing adapter, and BEIFR2 remediation engine. Each module receives a defined input, produces a defined output, and writes a state transition or receipt.

A standards-profile negotiation may select a standards profile for domain, identity, privacy, evidence, clearing, banking, ISO 20022 mapping, verifiable credential exchange, or jurisdictional compliance. If the receiving system cannot satisfy the selected profile, the system issues a CONFLICT marker or HOLD marker rather than silently downgrading the event. This provides a technical safety improvement over systems that allow unverified fallback behavior.

A verifier may reconstruct execution by retrieving canonicalization rules, policy version, selected profile digest, intent digest, evidence digest, RRec, ACR, and FinalityMarker. If reconstructed values do not match the artifact values, the verifier rejects finality or triggers a conflict workflow. Thus the BEI Internet is externally verifiable rather than dependent on operator trust.

### Internet Economy Redefinition—Value Network Embodiments

The BEI Internet Economy is implemented as a co-owner behavioral-economic value network. It does not treat a person merely as a user, subscriber, customer, or participant. A BEI co-owner identity endpoint acts as an origin node for verified life-time behavior events, object-confirmed actions, time-evidence records, and derivative value records.

A life-time behavior event may be admitted only after identity binding, domain-origin verification, time-coordinate qualification, object confirmation, evidence digesting, policy-container execution, non-duplication checking, and receipt generation. This prevents platform-style extraction from being treated as the economic source and instead places the BEI co-owner event root at the center of the value network.

The system may route a verified BEI-TVP or fission-root record to ATMS.com for asset-time-money-service/system processing, to BEIMINT.com or BEIMINTING.com for minting authorization, to MF.app as a mint factory or monetary factory endpoint, to BEICurrency.com for BEI Currency lifecycle management, to TimeCurrency endpoints for time-denominated value records, to BEIGX.com for exchange and licensing, to BEIIndex.com for index publication, and to BEIMarket for asset-package, license, transfer, grant, royalty, and diligence package generation.

The value network may generate BEI Currency units, TimeCurrency units, minting receipts, allocation records, reserve records, index records, license-use records, royalty-basis records, grant records, asset-package diligence records, BEI title/right records, collateral receipts, health-value records, object-life certification records, or correction-dependency records. Each generated output remains linked to the originating domain, identity, time, evidence, policy, and non-duplication references.

The system may compute a BEI Internet Economy index from behavior volume, behavior quality, time contribution, object-confirmation confidence, evidence strength, social impact, ecological impact, industry impact, jurisdictional impact, clearing finality, correction state, and license adoption. Such index output may be personal, family-level, industry-level, jurisdictional, national, regional, global, or asset-package-specific.

### Object Confirmation and Thousand-Edge Dependency Graph

The phrase multi-threaded or many-stranded behavioral-economic identity is implemented as a dependency graph having nodes and edges, not as a decorative metaphor. Nodes may include BEI co-owner identities, domain-origin basepoints, objects, time coordinates, evidence sources, policy containers, value records, currency units, index records, licenses, grants, royalties, clearing records, and remediation records. Edges may indicate origin, verification, derivation, dependency, transfer, license use, correction, or non-duplication relationship.

Object confirmation may bind the event to a physical object, digital object, medical record, IoT device, service object, transaction object, title object, domain parcel, time parcel, knowledge object, content object, evidence object, or asset-package object. A confirmed object may have an object identifier, object class, object-owner reference, evidence source, time coordinate, policy rule, object-state digest, and permissible derivative outputs.

The dependency graph supports non-obvious coupling among modules. The output of the domain-origin resolver is used as a verification input to the policy container; the output of the policy container is used as an input to the non-duplication controller; the output of the non-duplication controller gates BEIMINT and ATMS state transitions; the output of ATMS or ACR clearing is written back to update identity, index, license, and remediation states.

A correction dependency may be attached to each derivative record. If a source evidence object is later disputed, revoked, corrected, expired, or downgraded, the BEIFR2 engine computes an affected set through the dependency graph, limits the affected set by time-domain boundary and impact scope, and generates RBP or BEIClawback artifacts while preserving unaffected finality outside the boundary.

A non-duplication controller may compare a candidate event against prior identity records, time windows, object references, domain-origin references, event hashes, evidence digests, derivative graph references, license records, royalty-basis records, grant records, and asset-package inclusion records. When a prohibited duplicate is detected, the system may reject, limit, quarantine, or issue an authorized reuse condition.

### Non-Duplication Controller Algorithm

In one algorithmic embodiment, the Non-Duplication Controller builds a candidate key by canonicalizing and hashing at least identity_anchor, domain_origin_id, time_window, object_ref, behavior_type, evidence_digest, policy_container_id, authorized_reuse_flag, and correction_state. The controller queries prior root records, derivative records, license records, grant records, royalty-basis records, clearing records, index records, and asset-package inclusion records for matching or overlapping keys.

Example pseudocode may be represented as: receive candidate_event; normalize fields under schema_version; candidate_hash=H(identity_anchor∥domain_origin_id∥time_window∥object_ref∥behavior_type∥evidence_digest∥policy_container_id); prior_set=lookup(candidate_hash, overlap(time_window), object_ref, derivative_refs); if prior_set is empty then decision_code=ALLOW; else if authorized_reuse_flag is valid and reuse_condition is satisfied then decision_code=LIMIT; else decision_code=REJECT or CONFLICT; emit NonDuplicationReceipt (candidate_hash, prior_refs, reuse_condition, decision_code, reason_code, timestamp, signature).

The comparison may use exact equality, time-window overlap, object-state equivalence, evidence-digest inclusion, derivative-graph reachability, license-field overlap, grant-window overlap, royalty-basis overlap, or asset-package inclusion overlap. The output gate is applied before minting, clearing, indexing, licensing, royalty recognition, grant allocation, transfer, or asset-package inclusion, so a prohibited duplicate cannot become FINAL without a recorded authorized-reuse condition.

### Anti-Rejection Support and Examiner-Ready Structure

For Section 101, the technical improvement is not a statement that behavior has value. The improvement is a computer-implemented control plane that canonicalizes domain-origin intent envelopes, executes deterministic policy containers, emits proof-carrying receipts, coordinates atomic clearing records, publishes finality markers, computes bounded remediation proofs, and permits independent verifier reconstruction.

For Section 102, each core term is associated with a data structure and workflow. A DBN includes domain scope and policy endpoint fields. A BEI-TVP includes identity, domain, time, object, evidence, policy, non-duplication, and correction references. A fission-root record includes root, eligibility, audit, and derivative graph fields. RRec, ACR, Marker, and RBP include defined digest, proof, state, and signature bundles.

For Section 103, the invention is not a mere combination of DNS, DID, blockchain, token, payment, and marketplace modules. It is a non-conventional coupling in which the output of each upstream module becomes a verification input, state gate, or remediation boundary for a downstream module, and downstream receipts write back to identity, index, license, asset-package, and remediation states.

For Section 112, the disclosure provides field lists, state transitions, failure states, fallback modes, examples, flow diagrams, data structures, and claim-support mappings. A person of ordinary skill may implement embodiments using conventional processors, memory, network interfaces, databases, cryptographic hash functions, digital signatures, policy runtimes, message queues, ledgers, and external adapters without requiring specialized specialized nonstandard infrastructure.

Failure states include missing identity, expired time window, invalid object reference, weak evidence, failed policy predicate, duplicate value attempt, unsupported standards profile, downgrade detected, external rail timeout, conflicting ACR proof, stale index basis, revoked license scope, exceeded remediation boundary, and insufficient authority quorum. Each failure state may produce a reason code and remediation directive.

### Asset Package and Licensing Deepening

The asset-package layer may map each claim element to a software module, domain-origin functional node, API endpoint, trademark, patent-family reference, evidence object, standards interface, NeedPack, IndustryPack, JurisdictionPack, and license field. This mapping produces a diligence record suitable for data-room review, licensing negotiation, transfer evaluation, and portfolio valuation.

A Claim-to-SKU record may identify the covered claim, corresponding module, implementation endpoint, target industry, optional standards profile, dependency on other BEI modules, domain assets used, trademark reference, royalty basis, license slice, field of use, and audit evidence. The record may be emitted as a BEIMarket asset-package record and may be updated after RRec, ACR, or BEIFR2 events.

Licensing targets may include domain registries, DNS providers, identity platforms, wallets, banks, payment networks, clearing systems, exchanges, insurance platforms, medical systems, IoT platforms, supply-chain platforms, education systems, local governments, national digital identity systems, AI agent systems, standard-setting organizations, and enterprise compliance systems.

A data-room matrix may include patent-family rows, domain-asset rows, trademark rows, software-module rows, API rows, proof-artifact rows, clearing-record rows, index-record rows, license-record rows, royalty-basis rows, and remediation-record rows. Each row may reference one or more claim elements and one or more system artifacts generated during implementation.

The asset-package system is not merely a business valuation statement. It is a technical mapping engine that converts machine-generated artifacts and claim-supported modules into structured licensing and diligence records. This supports transfer, license, security, financing, insurance, index publication, and BEIMarket packaging without relying on unverified promotional statements.

### Implementation Examples Across Industries

In a medical-health embodiment, a clinical service event is received from a domain-rooted medical endpoint, bound to a BEI co-owner identity, patient or provider object, time-of-service coordinate, evidence record, consent policy, non-duplication reference, and health-value clearing profile. The system emits a BEI-TVP, RRec, optional health grain, ATMS settlement state, and index or license record.

In a restaurant or local-commerce embodiment, a service interval, order object, provider identity, customer identity, time window, receipt evidence, location evidence, and policy container are bound into a BEI-TVP. The system can route the event to TimeCurrency, BEI Currency, local index, supply-chain dependency graph, tax or compliance adapter, royalty-basis record, or local BEIMarket license package.

In an education embodiment, teaching time, learning activity, credential evidence, content object, institution domain, time coordinate, and quality-qualified evidence grade are recorded. The event may generate a verified learning contribution record, TimeCurrency unit, education index signal, certificate object, royalty-basis record for content usage, and remediation dependency for correction of credential evidence.

In an IoT embodiment, a sensor or device endpoint is bound to a DBN scope, object identifier, device attestation digest, time coordinate, evidence digest, policy container, and permitted action set. Device actions may be approved, limited, held, revoked, or remediated by the policy container, and the result may generate RRec, ACR, index, asset record, or BEIFR2 correction artifacts.

In a jurisdictional embodiment, city, state, national, or regional nodes aggregate BEI-TVP, TimeCurrency, BEI Currency, clearing, index, and correction records under jurisdiction packs and standards profiles. Outputs may include local reserve metrics, public benefit metrics, economic activity indices, grant records, regulatory audit packages, and license package summaries.

### Reportlab Drawing Support and Claim Map

The drawing set is intended as an engineering claim map. Each figure supports at least one independent claim, dependent claim group, core module, data structure, state machine, system loop, implementation example, or asset-package mapping. No figure is intended as decoration; each reference numeral corresponds to a described module, record, data flow, control flow, or state transition.

The preferred drawing generation workflow uses black-and-white vector PDF pages generated with Python ReportLab or an equivalent vector library. Each FIG page uses boxes, rounded boxes, ellipses, diamonds, database symbols, ledger-chain symbols, and open arrowheads. Arrow endpoints stop at the edge of source and target shapes, avoiding text and reference numerals.

The drawing engine may implement draw_box, draw_round_box, draw_ellipse, draw_diamond, draw_database, draw_ledger_chain, draw_wrapped_text, draw_reference_number, draw_open_arrow, calculate_edge_point, connect_shapes, check_overlap, draw_fig_title, generate_page, and build_pdf. The connect_shapes function preferably computes bounding boxes, centerline intersections, and edge points so that arrows do not enter modules or obscure text.

A figure may be rejected or revised if the specification does not explain it, the claims do not need it, the figure is merely decorative, the arrows do not represent data or state transitions, or the reference numerals are not traceable to the written description. A final drawing set should make the invention appear structured, implementable, and tied to claim elements.

### Detailed Module Input-Output and Failure-State Support

The DBN Resolver receives at least domain name, scope token, selected profile digest; processes the input under applicable domain-origin, identity, time, policy, and standards-profile rules; outputs at least namespace identifier, policy pointer, scope hash, anchor manifest; and records failure states including unresolved domain, stale anchor, policy mismatch, downgrade detected. The output may be written to RRec, ACR, Marker, RBP, NonDuplicationReceipt, BEI-TVP, fission-root, derivative graph, index, license, or asset-package records depending on the requested action and finality state.

The BEI Co-Owner Identity Resolver receives at least BEIDID, alias, credential, recognition level; processes the input under applicable domain-origin, identity, time, policy, and standards-profile rules; outputs at least identity anchor, immutable identifier, entitlement profile; and records failure states including expired credential, revoked status, insufficient recognition level. The output may be written to RRec, ACR, Marker, RBP, NonDuplicationReceipt, BEI-TVP, fission-root, derivative graph, index, license, or asset-package records depending on the requested action and finality state.

The Time-of-Time Engine receives at least timestamp, TimeGR, BEI-GR, service interval, attestation; processes the input under applicable domain-origin, identity, time, policy, and standards-profile rules; outputs at least time coordinate, time-evidence digest, time quality grade; and records failure states including expired window, overlapping time claim, missing attester. The output may be written to RRec, ACR, Marker, RBP, NonDuplicationReceipt, BEI-TVP, fission-root, derivative graph, index, license, or asset-package records depending on the requested action and finality state.

The Object Confirmation Gate receives at least object identifier, object class, object state, evidence; processes the input under applicable domain-origin, identity, time, policy, and standards-profile rules; outputs at least object reference, object-state digest, confirmation grade; and records failure states including missing object, conflicting object state, weak evidence. The output may be written to RRec, ACR, Marker, RBP, NonDuplicationReceipt, BEI-TVP, fission-root, derivative graph, index, license, or asset-package records depending on the requested action and finality state.

The Policy Container Kernel receives at least canonical intent, profile digest, evidence, identity, time; processes the input under applicable domain-origin, identity, time, policy, and standards-profile rules; outputs at least predicate vector, decision digest, allowed action set; and records failure states including failed predicate, policy version conflict, unsupported profile. The output may be written to RRec, ACR, Marker, RBP, NonDuplicationReceipt, BEI-TVP, fission-root, derivative graph, index, license, or asset-package records depending on the requested action and finality state.

The Non-Duplication Controller receives at least candidate event, prior event hashes, derivative graph; processes the input under applicable domain-origin, identity, time, policy, and standards-profile rules; outputs at least allow, limit, reject, authorized reuse condition; and records failure states including duplicate mint attempt, duplicate license basis, duplicate asset-package inclusion. The output may be written to RRec, ACR, Marker, RBP, NonDuplicationReceipt, BEI-TVP, fission-root, derivative graph, index, license, or asset-package records depending on the requested action and finality state.

The BEIMINT Node receives at least eligible BEI-TVP, fission root, policy decision; processes the input under applicable domain-origin, identity, time, policy, and standards-profile rules; outputs at least mint authorization, currency unit, allocation record; and records failure states including ineligible output, reserve predicate failure, policy hold. The output may be written to RRec, ACR, Marker, RBP, NonDuplicationReceipt, BEI-TVP, fission-root, derivative graph, index, license, or asset-package records depending on the requested action and finality state.

The ATMS Node receives at least asset/time/mint/money/service record, RRec; processes the input under applicable domain-origin, identity, time, policy, and standards-profile rules; outputs at least provisioning, settlement, clearing state, account state; and records failure states including insufficient entitlement, rail failure, conflict marker. The output may be written to RRec, ACR, Marker, RBP, NonDuplicationReceipt, BEI-TVP, fission-root, derivative graph, index, license, or asset-package records depending on the requested action and finality state.

The BEIGX Node receives at least license request, transfer request, asset package record; processes the input under applicable domain-origin, identity, time, policy, and standards-profile rules; outputs at least exchange listing, license transaction, transfer receipt; and records failure states including unverified title, unresolved dependency, non-final clearing. The output may be written to RRec, ACR, Marker, RBP, NonDuplicationReceipt, BEI-TVP, fission-root, derivative graph, index, license, or asset-package records depending on the requested action and finality state.

The BEIIndex Node receives at least RRec, ACR, BEI-TVP, correction state, weights; processes the input under applicable domain-origin, identity, time, policy, and standards-profile rules; outputs at least index value, index publication receipt, revision trail; and records failure states including stale evidence, invalid weight, unresolved correction. The output may be written to RRec, ACR, Marker, RBP, NonDuplicationReceipt, BEI-TVP, fission-root, derivative graph, index, license, or asset-package records depending on the requested action and finality state.

The BEIMarket Node receives at least claim-to-SKU record, domain asset map, license field; processes the input under applicable domain-origin, identity, time, policy, and standards-profile rules; outputs at least asset-package listing, data-room matrix, royalty basis; and records failure states including missing claim support, conflicting license, expired field-of-use. The output may be written to RRec, ACR, Marker, RBP, NonDuplicationReceipt, BEI-TVP, fission-root, derivative graph, index, license, or asset-package records depending on the requested action and finality state.

The BEIFR2 Engine receives at least conflict marker, impact graph, time boundary, scope cap; processes the input under applicable domain-origin, identity, time, policy, and standards-profile rules; outputs at least impact report, RBP, patch-set digest, correction receipts; and records failure states including exceeded boundary, insufficient quorum, unverifiable dependency. The output may be written to RRec, ACR, Marker, RBP, NonDuplicationReceipt, BEI-TVP, fission-root, derivative graph, index, license, or asset-package records depending on the requested action and finality state.

### Representative Machine-Readable Artifact Fields

Representative RRec fields may include namespace_id, subject_id, intent_digest, event_digest, policy_digest, evidence_digest, replay_value, time_coord, audit_commitment, signature_bundle, and receipt_digest.

Representative ACR fields may include clearing_intent_digest, rail_set, prepare_proof_set, commit_proof_set, finality_proof_set, result_state_digest, quorum_signature_bundle, external_reference_set, and finality_marker_reference.

Representative NonDuplicationReceipt fields may include candidate_hash, identity_anchor, domain_origin_id, time_window, object_ref, behavior_type, evidence_digest, prior_derivative_refs, authorized_reuse_condition, decision_code, reason_code, timestamp, and signature.

Representative RBP fields may include prior_state_digest, rollback_target_digest, new_state_digest, dependency_digest_set, bounded_window, impact_scope, patch_set_digest, supervisory_authorization_receipt, audit_refs, reason_code, and signature_bundle.

The foregoing artifact fields may be encoded as JSON, CBOR, protocol-buffer records, relational rows, ledger entries, transparency-log records, or equivalent canonical encodings, provided that canonicalization rules permit independent recomputation of at least one digest or proof value.

1. A computer-implemented domain-origin behavioral-economic Internet Economy infrastructure system comprising one or more standard hardware processors and non-transitory memory storing instructions that, when executed, cause the system to: (a) resolve a domain-origin basepoint defining a machine-resolvable namespace scope for a behavioral-economic identity co-owner endpoint; (b) bind a Time-of-Time coordinate, an object reference, a behavior-event type, an evidence digest, and a policy-container identifier into a behavior-economic packet record or behavior-time-value proof packet record, including a BEI-TVP record, or a fission-root record; (c) execute a deterministic policy container to evaluate a predicate vector comprising identity, time, object-confirmation, risk, compliance, privacy, non-duplication, minting, clearing, licensing, indexing, transfer, grant-allocation, asset-package, and remediation predicates; (d) enforce a non-duplication controller before minting, clearing, indexing, licensing, royalty recognition, transfer, grant allocation, or asset-package inclusion; (e) route an eligible record to domain-origin functional nodes comprising one or more of an asset-time settlement node, mint authorization node, currency lifecycle node, time-denominated value node, exchange node, clearing node, index node, market node, licensing node, or data-room node, including ATMS, BEIMINT, mint-factory, BEI Currency, TimeCurrency, BEIGX, BEIIndex, or BEIMarket nodes; (f) generate proof-carrying artifacts including a verifiable receipt, an atomic clearing record, and a finality marker; and (g) when a conflict, downgrade, duplicate, drift, fraud, dispute, or correction trigger is detected, generate a pre-execution impact report and a rollback proof constrained by a time-domain boundary and an impact-scope boundary while preserving an append-only audit trail.

2. The system of claim 1, wherein the domain-origin basepoint causes a network domain name to operate beyond a passive address-resolution label as a machine-resolvable, policy-governed, identity-binding, evidence-bearing, value-routing, and bounded-remediation-capable domain-origin infrastructure node.

3. The system of claim 1, wherein the Internet is implemented as a domain-origin technical control plane comprising domain basepoint nodes, behavioral-economic identity co-owner endpoints, deterministic policy containers, proof-carrying artifacts, atomic clearing records, finality markers, external verifier reconstruction data, and bounded remediation proofs that govern behavioral-economic state transitions across heterogeneous networks.

4. The system of claim 1, wherein the system implements a co-owner behavioral-economic value network in which object-confirmed life-time behavior events are converted into non-duplicative, policy-gated, receipt-backed, atomically cleared, indexable, licensable, transferable, grant-allocatable, asset-package-mappable, and bounded-remediable behavioral-economic value records.

5. The system of claim 1, wherein the root event record comprises a fission-root identifier, an identity anchor, a domain-origin identifier, a time window, an evidence hash, a policy-container identifier, a non-duplication hash, an output-eligibility profile, a correction state, a correction dependency, a derivative graph reference, and an audit anchor.

6. The system of claim 1, wherein the behavior-time-value proof packet record comprises an identity anchor, a domain-origin identifier, a time coordinate, an object reference, a behavior-event type, an evidence digest, a policy-container identifier, a non-duplication reference, and a correction-dependency reference, and may further comprise a Q-qualified evidence grade representing quality, qualification, and qualifier status of identity, time, object-confirmation, evidence, policy, and remediation fields without requiring a specialized nonstandard computing implementation.

7. The system of claim 1, wherein the proof-carrying artifacts comprise: (i) a verifiable receipt binding a namespace identifier, a subject identifier, an intent or event digest, a policy digest, an evidence or attestation digest, a replay-prevention value, a timestamp or time coordinate, an audit commitment, and a signature bundle; (ii) an atomic clearing record binding a clearing-intent digest, a rail or ledger set, prepare proofs, commit proofs, finality proofs, and a resulting state digest; and (iii) a finality marker indicating FINAL, CONFLICT, FROZEN, REJECTED, or REMEDIATED status.

8. The system of claim 1, wherein the non-duplication controller prevents or limits duplicate minting, clearing, indexing, licensing, grant allocation, royalty recognition, transfer, or asset-package inclusion by comparing at least an identity anchor, a domain-origin identifier, a time window, an object reference, a behavior-event type, an evidence digest, a prior derivative record, an authorized-reuse flag, and a correction state.

9. The system of claim 1, wherein the mint authorization node or mint-factory node generates at least one of a BEI Currency unit, a TimeCurrency unit, a minting receipt, an allocation record, a currency lifecycle record, a reserve record, or a non-fungible behavior record from a validated behavior-time-value proof packet record or root event record.

10. The system of claim 1, wherein the asset-time settlement node processes assets, time, minting, money, services, and system records and implements identity-bound provisioning, issuance, transfer, clearing, reconciliation, dispute callback, collateral, savings, lending, insurance, treasury, or reserve functions using the proof-carrying artifacts.

11. The system of claim 1, wherein the system exposes verifier reconstruction data comprising canonicalization rules, a schema version, a policy version, a selected standards-profile digest, an evidence digest, a receipt digest, an atomic-clearing digest, a finality marker, and a rollback proof, and causes an external verifier to recompute at least one digest and reject or mark CONFLICT when the recomputed value does not match the proof-carrying artifact.

12. A computer-implemented method comprising: (a) receiving an object-confirmed life-time behavior event; (b) resolving a domain-origin basepoint and a behavioral-economic identity co-owner endpoint; (c) binding a Time-of-Time coordinate, object reference, behavior-event type, evidence digest, and policy-container identifier; (d) canonicalizing the event into a behavior-economic packet record or behavior-time-value proof packet record, including a BEI-TVP record, or a fission-root record; (e) executing a deterministic policy container; (f) applying a non-duplication controller; (g) routing an eligible output to an asset-time settlement node, mint authorization node, currency lifecycle node, time-denominated value node, exchange node, index node, market node, licensing node, or data-room node; (h) generating a verifiable receipt and atomic clearing record; and (i) performing bounded remediation when a conflict, duplicate, downgrade, drift, fraud, dispute, or correction condition is detected.

13. The method of claim 12, wherein the Time-of-Time coordinate comprises a machine timestamp, a service-period marker, a life-time window, a TimeGR or BEI-GR value, a time-domain coordinate, and an attestation digest.

14. The method of claim 12, wherein object confirmation binds the behavior event to at least one of a physical object, digital object, medical record, IoT device, transaction object, title object, service record, communication entrance event, domain parcel, time parcel, or asset-package object.

15. The method of claim 12, wherein routing to the index node comprises computing an index value derived from aggregated behavior-time-value proof packet records, root event records, verifiable receipts, atomic clearing records, TimeCurrency records, BEI Currency records, correction-state records, industry-pack records, or jurisdiction-pack records, and binding the index value to an index publication receipt.

16. The method of claim 12, wherein routing to the market, licensing, or data-room node comprises generating a license record, transfer record, royalty-basis record, grant record, claim-to-SKU record, domain-asset mapping record, trademark mapping record, API mapping record, or asset-package diligence record.

17. The method of claim 12, wherein bounded remediation comprises computing a dependency graph, determining a bounded blast radius, generating a pre-execution impact report, generating a patch-set digest, requiring a supervisory authorization receipt, generating a rollback proof, and preserving prior audit commitments outside the impact-scope boundary.

18. The method of claim 12, wherein a standards-profile negotiation result having a downgrade-detected state causes issuance of a CONFLICT marker and prevents a FINAL marker until a selected standards profile digest, mapping digest, policy digest, or proof requirement is satisfied.

19. The method of claim 12, wherein a domain parcel or sovereign parcel is subdivided into a plurality of sub-parcels, branch nodes, store nodes, franchise nodes, time cells, industry cells, need cells, family or household cells, or jurisdiction cells, each governed by a policy container and associated with receipt-gated actions.

20. A non-transitory computer-readable medium storing instructions that, when executed by one or more processors, cause performance of operations comprising: resolving a domain-origin basepoint; generating a behavior-time-value proof packet record or root event record from an object-confirmed life-time behavior event; executing a deterministic policy container; applying a non-duplication controller; routing an eligible output to an asset-time settlement node, mint authorization node, currency lifecycle node, time-denominated value node, exchange node, index node, market node, licensing node, or data-room node; generating a verifiable receipt, atomic clearing record, and finality marker; exposing verifier reconstruction data; and generating a rollback proof constrained by time-domain and impact-scope boundaries when a conflict condition is detected, wherein the operations further comprise generating a claim-to-SKU-to-domain-to-market asset-package mapping record that links at least one claim element to a software module, domain-origin functional node, domain asset, trademark record, API record, NeedPack, IndustryPack, license field, royalty-basis record, and data-room evidence pointer.
